(19) United States
(12) Patent Application Publication
(10) Pub. No.: US 2026/0195843 A1
(43) Pub. Date: Jul. 9, 2026

(54) GRAPHICS DRIVER FOR DATA AWARE IMAGE POST PROCESSING

(71) Applicant: NVIDIA Corporation, Santa Clara, CA (US)

(72) Inventors: Ziad Ben Hadj-Alouane, Richmond, VA (US); David Kvasnica, Ottawa (CA); William Campbell, San Francisco, CA (US); Gary Kattan, North York (CA); Jason Mawdsley, Santa Clara, CA (US); Anand Raghavendran Purohit, Newark, CA (US); Gabriel Liberty, Sandy Springs, GA (US); Joshua Schnarr, Seattle, WA (US); Stephan Seitz, Lauf (DE); Jeffrey Juliano, Cary, NC (US)

(21) Appl. No.: 19/319,151

(22) Filed: Sep. 4, 2025

Related U.S. Application Data
(60) Provisional application No. 63/742,080, filed on Jan. 6, 2025.

(51) Int. Cl. G06T 1/20; G06T 15/00

(52) U.S. Cl. CPC G06T 1/20; G06T 15/005

(57) ABSTRACT

A method is provided for enhancing graphics processing by intercepting, at a swap chain adapter of a graphics driver, a frame packet originating from an application, where the frame packet contains a frame, associated frame data, and a first command intended for a swap chain of the graphics driver. The swap chain adapter replaces the first command with a second command, the second command being generated based on the frame data and tailored to specify post processing operations to be performed on the frame. The swap chain adapter then supplies an updated frame packet, which includes the second command, to the swap chain. The second command directs the swap chain to forward the frame to a post processor for the designated post processing. Following post processing, the method causes the display of the post processed frame.

### CROSS-REFERENCE TO RELATED APPLICATIONS

This application claims the benefit of U.S. Provisional Application No. 63/742,080 filed on Jan. 6, 2025, the entire contents of which are hereby incorporated by reference herein.

### BACKGROUND

Applications can provide or generate frames of images that can be displayed in an order, creating a motion sequence. To control the viewing experience of the motion sequence, each frame can be processed to provide enhanced images, smoother motion sequences, and the like. To display frames that achieve an enhancement goal, processing may be completed by the application generating the frames or by graphics processing unit resources. Technologies that allow for manipulation of frames to better achieve the enhancement goals can provide for better motion sequences or better resource management when displaying motion sequences

### BRIEF DESCRIPTION OF THE DRAWINGS

To easily identify the discussion of any particular element or act, the most significant digit or digits in a reference number refer to the figure number in which that element is first introduced.

FIG. 1 is a schematic block diagram of an example system architecture providing graphics driver for data aware image post processing, according to at least one embodiment;

FIG. 2 is an expanded view of the schematic block diagram of an example system architecture providing graphics driver for data aware image post processing of FIG. 1, according to at least one embodiment;

FIG. 3 is a flow diagram for presenting post processed frames on the architecture providing graphics driver for data aware image post processing of FIG. 1, according to at least one embodiment;

FIG. 4 is a flow diagram for post processing frames on the architecture providing graphics driver for data aware image post processing of FIG. 1, according to at least one embodiment;

FIG. 5 is a flow diagram of an example method of graphics driver for data aware image post processing, according to at least one embodiment;

FIG. 6A illustrates a computer system, according to at least one embodiment;

FIG. 6B illustrates a computer system, according to at least one embodiment;

FIG. 6C illustrates a computer system, according to at least one embodiment;

FIG. 6D illustrates a computer system, according to at least one embodiment;

FIGS. 6E and 6F illustrate a shared programming model, according to at least one embodiment;

FIG. 7 illustrates exemplary integrated circuits and associated graphics processors, according to at least one embodiment;

FIGS. 8A-8B illustrate exemplary integrated circuits and associated graphics processors, according to at least one embodiment;

FIGS. 9A-9B illustrate additional exemplary graphics processor logic according to at least one embodiment;

FIG. 10 illustrates a multi-graphics processing unit (GPU) system, according to at least one embodiment;

FIG. 11 illustrates a graphics processor, according to at least one embodiment;

FIG. 12 illustrates at least portions of a graphics processor, according to one or more embodiments;

FIG. 13 illustrates at least portions of a graphics processor, according to one or more embodiments;

FIG. 14 illustrates at least portions of a graphics processor, according to one or more embodiments; and

FIG. 15 is a block diagram of a graphics processing engine of a graphics processor in accordance with at least one embodiment.

### DETAILED DESCRIPTION

Embodiments of the present disclosure are directed to methods and systems that can intercept communications from an application generating frames of a motion sequence to capture all applicable frame data, and then cause processing of the frame data by a graphics driver for robust post processing of the frame data. Embodiments introduce additional logic that may be implemented as a plugin or extension of an application that intercepts communications with a swap chain of a graphics driver and communicates with the swap chain on the application's behalf. Intercepting communications may allow for driver functionalities to be enhanced without a need for the application to be altered. The interception may be at a swap chain adapter that can provide commands to the swap chain. The swap chain may act as a queue between the application and the graphics driver to allow for frames and commands to be provided from the application to the graphics driver for post processing and display. The swap chain adapter may intercept and modify frames and commands provided to the swap chain to enable additional post processing within the graphics driver for spatial, temporal, and/or variable characteristic modifications to increase the appearance and/or smoothness of the motion sequence in embodiments.

Graphical applications, such as three-dimensional (3D) graphical applications benefit from the ability to apply various post-processing effects to an intended output image or frame. For example, applications may apply sharpening, color filtering, conversion from SDR to HDR, frame rate increase, and so on. For applications that rely on a graphics driver to perform these post-processing operations, the availability of such operations may be limited. Post-processing that is performed within a graphics driver generally execute work in siloed units. For example, a graphics driver may be able to submit commands to a graphical processing unit (GPU), but may not have any context that it can provide with the commands.

In embodiments, a driver module, referred to as a swap chain adapter is interposed between an application and a graphics driver. The swap chain adapter may be an extension of the application. The application may submit work to the graphics driver, and the swap chain adapter may intercept the work and determine context surrounding the work sufficient to perform post-processing effectively and efficiently. In embodiments, the swap chain adapter is an extension of the application that maintains control over the applications swap chain. The swap chain adapter is able to identify what API calls the application makes to the swap chain, and then perform operations accordingly.

When an application presents an image to the swap chain, the swap chain adapter intercepts the image and associated command, and seamlessly executes post-processing work (either synchronously or asynchronously), and enables the application to continue its operations as if no post-processing work were to be performed. Once the post-processing work is complete, the swap chain adapter continues communicating with the graphics driver as if the swap chain adapter were the application.

Embodiments enable post-processing effects to be performed by a graphics driver in a context-aware manner that improves performance and image quality.

Existing technologies may attempt to affect the frame spatial characteristics, temporal characteristics of frames, and/or variability of frames of a motion sequence. Such technologies may receive frames from an application at a swap chain within a graphics driver. A swap chain may be a buffer queue that manages frame rendering and presentation between the application and the graphics driver. The swap chain may be used to cause smooth delivery of frames, support double/triple buffering, and handle synchronization with the display refresh cycle by controlling the presentation of the frames to the driver for processing and display. The frames may be manipulated by an in-driver module that receives images from the swap chain. However, frames provided from a swap chain may have limited frame data. For example, the frame data may be limited to data surmisable from the frame itself, such as size and format. Additional data that is not transmitted from the swap chain may be useful to execute additional post processing. The swap chain may then maintain the frame until the application directs the swap chain to display the frame with a command.

Spatial characteristic post processing may be done within the application after generation of the frame. For example, the application may increase the resolution or adjust the coloring of the frame prior to providing the frame to the driver for display. Temporal characteristic post processing may include increasing the smoothness of the motion sequence that is dependent upon the frame rate. In an example, an application may be generating frames that may be displayed at 30 frames per second. Based on the application's functionalities, the application may be detrimentally affected by attempts to generate additional frames to increase the frame rate. Additional frames that can be displayed between the frames generated by the application may allow for the frame rate to increase allowing for a smoother motion sequence. However, additional frame generation may be limited without access to frame data that is lost by the swap chain. Existing technologies may guess at the frame data to attempt to generate the additional frames to varying levels of success.

Frame variability may be caused by an inconsistent frame generation at the application. The application may be generating frames of varied complexity or may be running multiple processes at some times, causing frame generation of some frames to slow. Varied generation of frames may lead to delayed display from the swap chain, causing the motion sequence to be less smooth or of lower quality. Existing technologies may rely on directions from the application to manage display times of each frame to limit frame variability.

Post processing may be used to maintain all relevant frame data for each frame provided to the swap chain. In embodiments, a swap chain adapter can intercept frames and/or a frame packet provided from the application to the swap chain. The swap chain adapter may collect all frame data associated with the frame and/or provided as part of the frame packet that the swap chain would normally discard. For example, the frame data may include image data such as pixel values, image format, texture data, frame buffer data, synchronization data, display resolution, refresh rate, presentation mode, shaders, state configuration, and the like. The swap chain adapter may further access context related to the generation and display of frames such as buffer times for post processing, generation rates of the application, and the like.

After collecting the frame data, the swap chain adapter may provide the frame to the swap chain through expected communications channels. Specifically, the swap chain adapter may provide the frame to the swap chain such that the swap chain is unaware that the frame was received from a source other than the application (e.g., from the swap chain adapter). The swap chain adapter may provide the frame and the command as if they originated from the application. The command may be included in the frame packet or may be provided individually from the frame. Alternatively, the swap chain adapter may provide the frame with a replacement command. For example, the application may provide a frame to the swap chain with the command “wait” to direct the swap chain to maintain the frame until the application directs display of the frame. If the swap chain adapter does not intend to complete any additional post processing on the frame, the swap chain adapter may pass along the frame and command unchanged. However, if the swap chain adapter determines that additional post processing is to be performed, the swap chain adapter may provide the frame along with instructions to send the frame along to memory resources to complete additional post processing. The swap chain would not be aware that the initial command and the received command were not the same command, and will act according to the command from the swap chain adapter.

After providing the frame and the command to the swap chain to provide the frame to a post processor on the driver, the swap chain adapter may provide relevant data to the post processor. For example, the post processor may be capable of generating multiple frames based on a provided frame or set of frames. To generate the additional frames, the post processor may use the resolution, image format, refresh rate, presentation mode, and the like associated with the frame. Using the frame and the additional data, the post processor may generate one or more additional frames to be displayed between the frame and a subsequent frame, increasing the frame rate. The post processor may provide the generated frames back to the swap chain.

The swap chain adapter may intercept the frames provided by the post processor to the swap chain to identify the number of frames generated. Based on the number of frames generated, the swap chain adapter may provide the frames to the swap chain with a command to display the frames according to a timing coordinator. The timing coordinator may be stored on the driver and may determine optimal display times for frames based on the frame rate intended by the number of frames and/or based on the consistency of frames provided by the application.

Because the application is unaware of the additional frames being generated, display commands provided by the application may not provide for the additional frames. The timing coordinator may provide timing information and/or timing commands to the swap chain for displaying the additional frames. Further, the application may provide the frames at inconsistent times. The swap chain adapter may cause the swap chain to display according to timing commands from the timing coordinator, which may differ from a timing of frames provided by the application. This may improve a smoothness at which frames are presented.

Some frames may, based on contents and/or processing needs, have longer buffer and/or render times after the display command is provided to the swap chain. The application may be unaware of the increased buffer time and/or render time and may provide the display command too late for smooth motion sequences and/or may command a subsequent display of subsequent frames too quickly. The swap chain adapter may command the swap chain to request timing from the timing coordinator based on the buffering. For example, if a first frame is slow to buffer after the command to display, the second frame may be delayed even after a display command from the application is generated, to keep consistent frame display timing.

Applications and methods herein utilize a swap chain adapter that intercepts communications from the application to the swap chain to capture all applicable frame data that would be lost by the swap chain executing the application commands. Attempts to adapt the driver to enable additional post processing not included in the application commands have traditionally caused increased latency. Additionally, even if the driver were adjusted to support more post-processing, the data from the swap chain may still be in sufficient for advanced operations.

Utilization of the swap chain adapter allows for applications to be unaware of changes in the post processing at the driver, and driver functionalities to be enhanced without swap chain, driver, or application adjustments. The swap chain adapter may intercept communications from the application to the swap chain and may review them to check alignment with enhanced post processing metrics. The swap chain adapter can intercept a command and instead of, or in addition to, the original command, may provide commands to the swap chain to allow for post processing within the driver the application is unaware of. The additional post processing may include spatial, temporal, and/or variable characteristic modifications to increase the appearance and/or smoothness of the motion sequence made up of the collection of frames from the application.

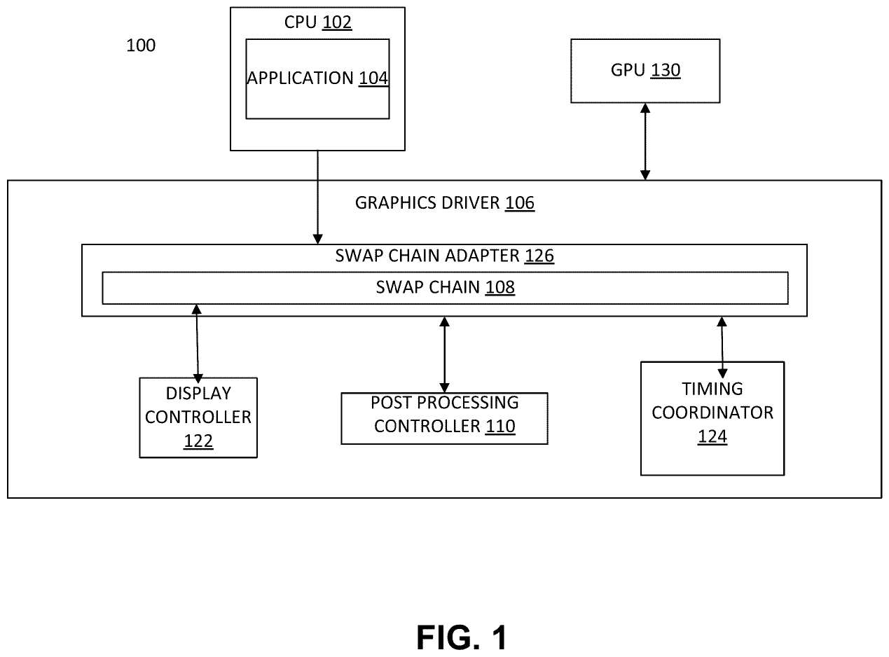

FIG. 1 is a schematic block diagram of an example system architecture 100 providing a graphics driver 106 for data aware image post processing, according to at least one embodiment. Data aware image post processing can be performed using a system such as the system architecture 100 of FIG. 1. The system may include a central processing unit (CPU) 102 that may perform computations to execute logic and instructions from programs to carry out tasks and manage system operations.

The CPU 102 may support running an application 104 and may receive data and/or instructions from the application 104 in order to support the generation and display of frames within a motion sequence. The application 104 may be, for example, a video game, video editing software, an animation and motion graphics tool, a web browser, a media player, a mobile app, a visual performance tool, and/or a scientific visualization and simulation tool. The application 104 may generate frames over time that can be provided to the graphics driver 106 for rendering to a display, whether for real-time display (e.g., games, simulations) or for editing/export (e.g., video editing and animation). In some embodiments, the CPU 102 may prepare the data and instructions for rendering the frames. In some embodiments, the CPU 102 may execute post processing on frames. In some embodiments, post processing by the CPU 102 may include color correction, sharpening, blurring, tone mapping, noise reduction, motion blur, bloom, depth of field, vignette, lens distortion correction, and visual effects such as film grain or stylization. Aspects of the graphics driver 106 may be performed on the CPU 102 and/or an external CPU 102 supporting the application 104. The graphics driver 106 may utilize the CPU 102 or other CPUs to generate commands and execute logic. The commands may be provided to a GPU for execution. For example, the graphics driver 106 may be used to determine a need for post processing or display, and the post processing or display may be handled by computational resources of a GPU.

The application 104 may generate multiple frames for display in a sequence to create a motion sequence. The application 104 may include, for example, games that compute scene logic, physics, and player input to produce rendering instructions for a compressed video stream. The video stream may comprise individual frames for display at a frame rate which may be the number of individual frames or images displayed per second in a video or animation, typically measured in frames per second (FPS). The application 104 may provide frames for immediate display according to the frame rate or may provide frames for display and cause display of the provided frames at a later interval once the frames are determined to be displayed by the application 104. Frames that animate movement may be generated, post processed, and provided to a graphics driver 106 for immediate display or to be the next frame displayed according to the frame rate. For example, the application 104 may be a video game application that produces frames as a character is moved through a landscape in the display. As soon as the player moves the character, the application 104 may generate a frame and send it for immediate display. In another example, the application 104 may provide frames slightly in advance of their intended display to allow time for frame rendering by computing resources. Upon determination that an interval of the frame rate has occurred that corresponds with the intended display of the frame, the application 104 may provide instructions to display the frame.

Another example may include the application 104 as a video game that has multiple menus based on selections on a first menu. For example, the player could pick a first choice on a first menu that leads to a second menu, or a second choice on the first menu that leads to a third menu. Understanding either the second menu or the third menu will be the subject of the subsequent frame, the application may generate frames in anticipation and provide both options to the graphics driver 106 for rendering. Following the indication from the player of the game, the application 104 may provide a display function for the menu corresponding with the player selection.

In some embodiments, the instructions and the frames may be provided to a graphics driver 106 from the application 104. In some embodiments, the graphics driver 106 can be software that acts as a bridge between the CPU 102 and the GPU 130, translating high-level rendering commands into low-level instructions the graphics hardware can execute to generate and display each frame. The graphics driver 106 may generate the instructions to execute post processing, frame generation, and frame display graphics driver 106 functionalities on the GPU 130. As described above, the graphics driver 106 may be executed on CPU 102, or may be executed on other CPU resources and may receive commands and frame data from the application 104 on CPU 102. The application 104 may direct the creation of a swap chain 108 on the graphics driver 106. The swap chain 108 may be a collection of image buffers used in graphics rendering that allows smooth presentation of frames by swapping between rendered images and an image currently displayed on screen. The application 104 may generate commands for, and may provide frame packets to, the swap chain 108. In some embodiments, a command may include instructions to acquire a next image, present the image, resize buffers, synchronize frame presentation, and the like. The command may be provided with or without a frame packet. A frame packet may include a frame and frame data. The frame may be a collection of pixels, a rendered image or buffer, or location information to find the image stored in a database.

When the application 104 generates a frame, it may also create or associate a variety of frame data (e.g., metadata) that guides how the frame is rendered, synchronized, and managed. In some embodiments, frame data can include transformation matrices such as model, view, and projection matrices, which define how objects are positioned and viewed in the scene. Frame data may include lighting data like the positions, colors, and intensities of light sources, as well as material properties such as textures, reflectivity, and roughness that define the appearance of objects. Further frame data may include shader parameters or uniforms such as color values, time-based variables, and effect toggles.

In some embodiments, the application 104 may generate timestamps marking when the frame started, when it was submitted to the GPU 130, and when it is scheduled for presentation. Synchronization frame data might include references to semaphores or fences used to coordinate GPU 130 and CPU 102 workloads. Based on a received command to display the frame from the application 104, the swap chain 108 may cause the display controller 122 to display the frame using a GPU 130.

In some embodiments, some types of post processing may not be executable by the CPU 102. Based on post processing to be performed, some or all of the frame data may be needed. To ensure the frame data is preserved within the graphics driver 106, a swap chain adapter 126 may act as an intermediary between the swap chain 108 and the application 104 without an adaptation of application 104 functions. To mediate between the application 104 and the swap chain 108, the swap chain adapter 126 may intercept frame packets, including commands, from the application 104. The swap chain adapter 126 may collect and utilize frame data that is discarded by the swap chain 108. The swap chain adapter 126 may determine that additional post processing is called for based on the frame packet. In some embodiments, the swap chain adapter 126 may evaluate the frame data to determine the specific post-processing requirements of the frame, such as the need for upscaling, frame generation, color correction, and the like. Based on these requirements, it may adjust the command within the frame packet before providing the frame packet to the swap chain 108. For example, the frame packet may include a frame and a command to display the frame. However, the application 104 may have provided the frame earlier than needed for a consistent frame display.

Immediate compliance with the command may cause the next time between frames to be inconsistent with prior time between frames, and the motion sequence to appear jittery to the user. The jitter may occur by the increase in frame rate by showing the received frame too soon after the previous frame or by an increased delay between the received frame and the subsequent frame that may be received.

The swap chain adapter 126 may change the command from the frame packet to cause data to be provided to the timing coordinator 124. The timing coordinator 124 may monitor the frame rate generation of the application 104 and rendering time of the swap chain 108 to identify timing adjustments for display commands. Timing adjustments may include delaying display of one or more frames in the motion sequence with the same or varying delay times. For example, if the rendering of one frame is longer than normal, the timing coordinator 124 may cause the next frame to delay display until the normal time between frames of the designated frame rate has passed. Alternatively, the timing coordinator 124 may attempt to get the frames back on the original display increments and may decrease the time between displays until the displays are once again synced with the commands from the application 104, and then may return to a regular or predetermined time between displays for the frame rate.

In some embodiments, the swap chain adapter 126 may identify additional post processing to be performed for the frame. The swap chain adapter 126 may change the command to cause the swap chain 108 to deliver the frame packet or data from the frame packet to the post processing controller 110. Using the data, the post processing controller 110 may process the frame using any of the post processing techniques listed above, or may duplicate the frame. Turning one frame into multiple frames may be suggested to the swap chain adapter 126 and/or by the timing coordinator 124 based on a frame rate being too slow and/or sporadic such that the motion sequence would be smoother with additional frames between frames provided by the swap chain adapter 126. The swap chain adapter 126 may receive the additional frames and display them, or cause display of them, at the timing indicated by the timing coordinator 124. The frames may then be provided to the display controller 122 for display.

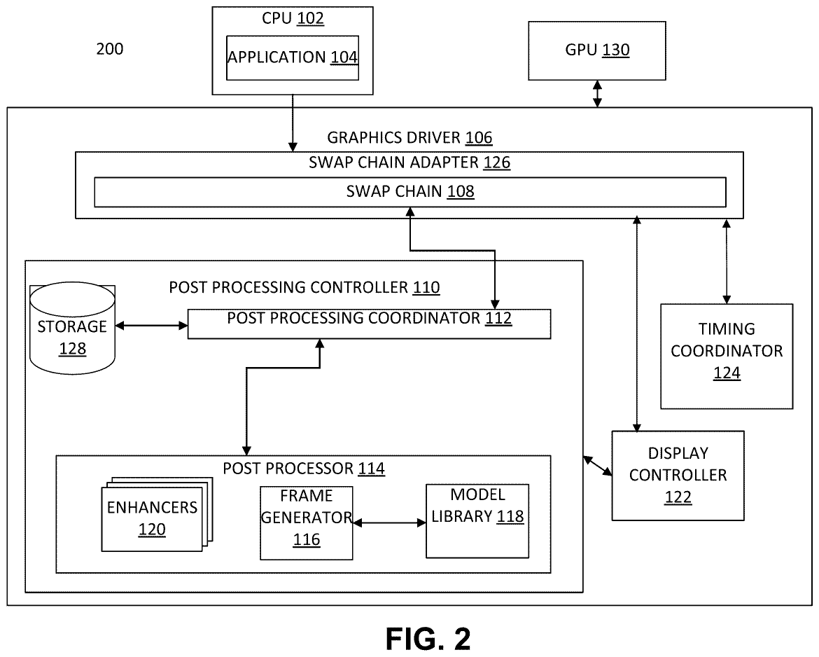

FIG. 2 is an expanded view of the schematic block diagram of an example system architecture 200 providing a graphics driver for data aware image post processing of FIG. 1, according to at least one embodiment. The application 104 on the CPU 102 may provide a frame packet that may include an original command to a swap chain 108 of the graphics driver 106 as described in FIG. 1. The swap chain adapter 126 may intercept the frame packet and may determine to adjust the original command of the frame packet prior to providing the updated frame packet with the new command to the swap chain 108. In some embodiments, the swap chain adapter 126 may determine additional post processing to be performed on the GPU 130 computational resources. The command may direct the swap chain 108 to provide the frame data and frame of the frame packet to the post processing controller 110 at the post processing coordinator 112. The post processing coordinator 112 may identify the type of post processing that is to be done on the frame. The post processing coordinator 112 may provide the frame and frame data to a post processor 114 to be processed by enhancers 120 and/or a frame generator 116. The enhancers 120 may utilize GPU 130 resources for post processing that may utilize too many computational resources for the CPU 102 that are better supported by the GPU 130. The enhancers 120 may, for example, complete blur, bloom, tone mapping, color grading, and/or other parallel pixel operations.

In some embodiments, the swap chain adapter 126 may determine, using the timing coordinator 124, that additional frames based on the frame should be generated. The post processing coordinator 112 may provide the frame packet to the frame generator 116 of the post processor 114. In some embodiments, duplicating the frame involves creating one or more identical copies of the rendered image and its associated rendering context so it can be reused, displayed again, or processed independently. The frame generator 116 may utilize the image buffer data provided to the frame generator 116 as part of the frame data of the frame packet, and may allocate a new buffer to store the duplicate. The duplication process may involve a direct GPU-to-GPU copy, a CPU readback followed by re-upload, or the use of a shared image handle depending on the platform and API. Along with the image data, frame data such as the frame's resolution, color format, transformation matrices, shader parameters, and/or synchronization objects (like semaphores or fences) may also be replicated or referenced to preserve the rendering context. This ensures that the duplicated frame can be used seamlessly in scenarios like preview rendering, frame analysis, delayed presentation, or multi-display output.

In some embodiments, the frame generator 116 and/or the enhancers 120 may utilize one or more AI models from a model library 118. The AI models may aid the enhancers 120 and the frame generator 116 in executing the post processing tasks. AI models may be used to generate visual effects, enhance image quality, or interpret image content. For example, AI models may be used to upscale resolution by reconstructing frames, denoise artifacts within the frame, apply a style, interpolate frames and smooth motion, color grade, and the like. Frame interpolation may include generating a frame to be displayed between two frames provided by the application 104. AI models may include neural networks (e.g., convolutional neural networks), generative models (e.g., diffusion models or generative adversarial networks (GANs), and/or other types of models. In some embodiments, AI models are not used for frame enhancement.

After the post processing operations within the post processor 114 have been completed, the post processor 114 may provide the processed frame(s) to the post processing coordinator 112. The post processing coordinator 112 may provide the frame(s) back to the swap chain 108 for timed display using the display controller 122, or the frames may be stored in a storage 128 until the swap chain 108 requests display of the frame(s). In some embodiments, the swap chain adapter 126 may cause the swap chain 108 to direct the frame(s) from the storage 128 to the display controller 122.

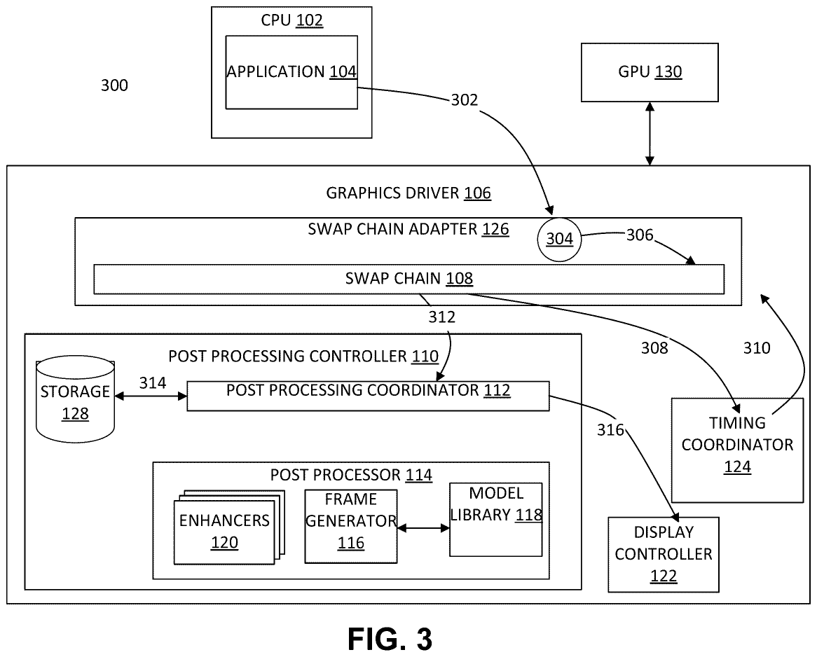

FIG. 3 is a flow diagram 300 for presenting post processed frames on the architecture providing a graphics driver for data aware image post processing of FIG. 1, according to at least one embodiment. In some embodiments, the application 104 may provide 302 a frame packet to the swap chain 108 that is intercepted 304 by the swap chain adapter 126. The swap chain adapter 126 may adjust the command of the frame packet and provide 306 the frame packet with the new command to the swap chain 108. In some embodiments, the swap chain adapter 126 may determine that display of the provided frame(s) are to be timed in a timing different than is specified by the application 104 for a motion sequence. A consistent and sufficiently high frame rate (e.g., 60 FPS) can enable motion to appear fluid to the human eye, reducing jitter and visual stuttering. When frames are presented at uneven intervals or dropped entirely, motion appears choppy or erratic, which can break immersion, cause discomfort, or hinder usability-especially in interactive applications like games or virtual reality. High frame rates may reduce input latency, making user interactions feel more immediate and responsive. In some embodiments, the application 104 may not consistently generate frames fast enough due to CPU 102 or GPU 130 bottlenecks, causing delays or dropped frames. Resource contention, garbage collection, and/or large scene updates can further interrupt timing of displaying frames. Additionally, mismatches between the application's frame output rate and a display refresh rate can cause tearing or stutter if not properly synchronized. Even if the application renders on time, delays in the graphics driver 106 and/or swap chain 108, for example late image acquisition or buffer availability issues, can lead to frames being delayed.

To determine a proper timing for the frames provided by the application 104, the swap chain adapter 126 may direct the swap chain 108 to provide 308 the frame packet to the timing coordinator 124 for analysis. The timing coordinator 124 may analyze the data from the frame packet and previous frame packets to determine a display time for the frame that enables improved motion sequence display.

In some embodiments, the timing coordinator 124 may provide 310 information to the swap chain adapter 126 to cause display of the frames to align with a display's refresh cycle. In some embodiments, the timing coordinator 124 may dynamically match the display's refresh rate to the GPU's frame output rate for each frame provided to the graphics driver 106 from the application 104. In some embodiments, the timing coordinator 124 may provide instructions to the swap chain adapter 126 to enforce a consistent display interval between frames to smooth out variability in the application's frame generation rate. In some embodiments, the timing coordinator 124 may determine that additional frames are to be populated to be displayed between frames from the application 104 to increase the frame rate. In some embodiments, the timing coordinator 124 may cause dropping or delaying of a frame selectively—such as skipping a duplicate frame or repeating the last good frame to avoid motion sequence issues. The swap chain 108 may, based on the timing analysis from the timing coordinator 124, provide 312 the frame packet to the post processing controller 110 for rendering and immediate or subsequent display. The post processing coordinator 112 may store 314 the frame packet in the storage 314 and provide the frame packet for display 316 at the display controller 122.

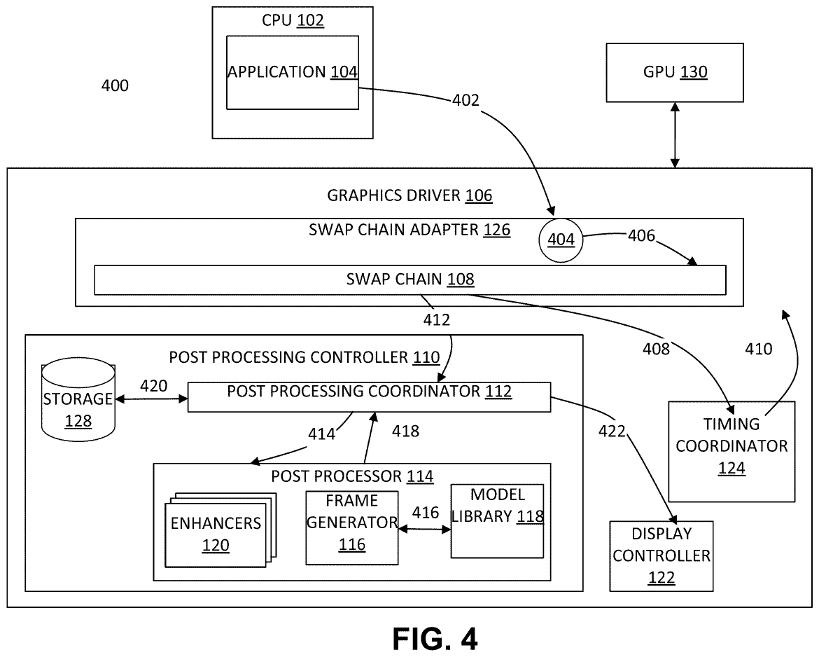

FIG. 4 is a flow diagram 400 for post processing frames on the architecture providing a graphics driver for data aware image post processing of FIG. 1, according to at least one embodiment. The application 104 may provide 402 the frame packet to the swap chain 108. The frame packet may include a frame, frame data, and/or a command for the swap chain 108. The swap chain adapter 126 may intercept 404 the frame packet and may evaluate the frame packet to determine a command for the swap chain 108. The evaluation by the swap chain adapter 126 may be performed using information previously provided by the timing coordinator 124 to generate a command. The evaluation may instead, or in addition to, generate a command to gain information to make an additional evaluation to generate a command. The swap chain adapter 126 may replace the command in the frame packet and provide 406 the frame packet with the replaced frame to the swap chain 108. In some embodiments, the command may be to display the frame, provide the frame and frame data to the post processor 114 for post processing, provide the frame to the timing coordinator 124 for timing analysis, and so on. Timing analysis may be used by the swap chain adapter 126 to determine display instructions to utilize with and/or instead of display instructions from the application 104.

As described above, consistent display of frames within a motion sequence can affect display quality. In some embodiments, the application 104 may not produce frames with a fast enough frame rate to match with the display refresh rate of the display and/or be displayed to create a smooth motion sequence. To address frame timing issues and improve the smoothness of motion sequences, the timing coordinator 124 can be used to adjust the display timing of one or more frames. The frame packet may include a command to provide 408 the frame packet to the timing coordinator 124 for a timing analysis. The timing analysis may be performed by identify a frame rate having been established by the application 104 during previous frame display commands. The timing analysis may determine how closely aligned the commands to display frames are to the intended frame rate indicated by the application 104 commands. The timing analysis may also include identifying the aspects of the display device that may involve display. The analysis may combine the collected information to determine if the timing from the application 104 is consistent and compatible with the display device. The timing coordinator 124 may provide 410 back data associated with the determined timing. In some embodiments, the timing coordinator 124 may identify a new frame rate for the swap chain adapter 126 to identify a number of frames to generate. In some embodiments, the timing coordinator 124 may determine the number of frames to generate.

In some embodiments, the command may direct the swap chain 108 to provide 412 the frame packet to the post processing controller 110 at the post processing coordinator 112 for post processing. In some embodiments, the post processing coordinator 112 may determine the post processing that is to be done on the frame of the frame packet and may provide 414 the frame packet to the post processor 114 for post processing at the enhancers 120 and/or at the frame generator 116. In some embodiments, having identified at the timing coordinator that additional frames are called for, the frame generator 116 may utilize 416 one or more AI models of the model library 118 to duplicate the frame of the frame packet and/or to generate one or more new frames. In some embodiments, the number of frames to be created may be identified by the timing coordinator 124 or by the swap chain adapter 126 based on the timing analysis of the timing coordinator 124. For example, the timing coordinator 124 may identify a target frame rate and a current frame rate. Based on a comparison of the two frame rates, the swap chain adapter 126 may identify a number of frames to be created and displayed between frames provided by the application 104. In some embodiments duplication of a rendered frame may call for comprehensive frame data encompassing all elements necessary to accurately reproduce the visual output. In some embodiments, duplication may be generating a replica of the frame to display or interpolating a frame to display between two frames that depict different images. The frame data may include the vertex and geometry data defining the 3D objects within the scene, associated textures and material properties that dictate surface appearance, and/or shader programs along with their parameters to apply lighting, shading, and/or visual effects. Further data may include camera configuration and transformation matrices to replicate the exact viewpoint and spatial positioning of objects, as well as detailed lighting information including type, position, and/or intensity of light sources. Render states and pipeline settings such as blending modes and depth testing parameters may be used to ensure consistent rendering behavior. Additionally, the frame buffer content including color and depth information may be utilized.

The post processor 114 may provide 418 the frame packet or just the duplicate or interpolated frames to the post processing coordinator 112. The post processing coordinator 112 may store 420 the duplicate frames in the storage 128 until the display command is generated by the swap chain adapter 126 based on the frame rate called for to meet visual objectives. In some embodiments, the frame received from the application 104 may be immediately displayed such that a duplicate frame should be displayed soon after generation. The swap chain adapter 126 separately, or with the frame packet, may instruct the post processing coordinator 112 to provide 422 the duplicated frame directly to the display controller 122 for display.

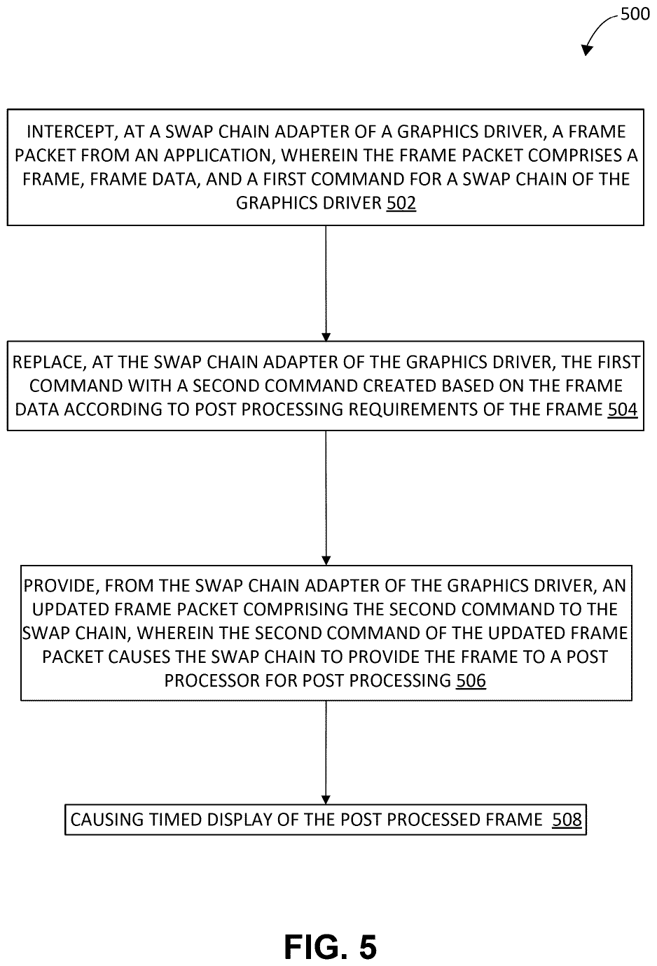

FIG. 5 is a flow diagram 500 of an example method of graphics driver for data aware image post processing, according to at least one embodiment. In block 502, the system intercepts, at a swap chain 108 adapter of a graphics driver 106, a frame packet from an application 104, wherein the frame packet comprises a frame, frame data, and a first command for a swap chain 108 of the graphics driver. In some embodiments, the first command from the application to render or display the frame. In some embodiments, frame rendering may be directed by the graphics driver 106 cause the GPU 130 execute a series of operations, (e.g., one or more post processing operations), including scene setup, geometry processing, lighting, and rasterization to transform 3D objects into 2D pixels, applying textures, lighting, and/or effects to produce the final visual output on screen.

In some embodiments, the frame data may comprise resolution, frame buffer data, and synchronization data associated with the frame. Resolution may include the number of pixels to be displayed on a screen or image, typically defined as width×height (e.g., 1920×1080). Resolution may be directly correlated to the level of detail and clarity of the frame. In some embodiments, the graphics driver 106 may compare the resolution of the frame to a resolution of the screen to determine any additional processing to be completed before the frame can be displayed on the screen. In some embodiments, frame buffer data may include, but is not limited to, color values, depth (z-buffer), stencil values, and sometimes additional information like alpha (transparency) and/or motion vectors. In some embodiments, synchronization data may refer to the information and mechanisms used to coordinate the timing between the CPUs 102 and GPU 130 to checks that determine that frames are processed and displayed in the correct order. Synchronization data may include, but is not limited to, frame timing, vertical sync (V-Sync), semaphores, fences, and frame indices to manage buffer swapping and avoid issues like tearing or stuttering.

In some embodiments, the graphics driver 106 may determine, using a timing coordinator 124, a frame rate for the frame and the one or more additional frames. The application 104 may or may not provide a frame rate with the packet. However, as described above, display of the frames provided by the application 104 and intended to be displayed at the frame rate may be delayed by post processing, application 104 frame packet delays, and the like. The timing coordinator 124 may be used to check an accurate frame rate, determine a higher frame rate is necessary, determine that higher frame rate, determine adjustments to be made to displays to synchronize with the frame rate, and the like.

In block 504, the system replaces, at the swap chain adapter 126 of the graphics driver 106, the first command with a second command created based on the frame data according to post processing to be performed on the frame (e.g., post processing requirements of the frame). As described above, the swap chain adapter 126 may decide that the first command provided by the application 104 should not be immediately executed. For example, if the swap chain adapter 126 determines additional post processing is to be performed, the first command to render and display the frame may be disregarded in favor of a command to provide the frame from the swap chain 108 to the post processor 114. In some embodiments, the swap chain adapter 126 may maintain the first command such that once the post processing is completed, the swap chain adapter 126 may command the swap chain 108 to display the frame.

In block 506, the system provides, from the swap chain adapter 126 of the graphics driver 106, an updated frame packet comprising the second command to the swap chain 108, wherein the second command of the updated frame packet causes the swap chain 108 to provide the frame to a post processor 114 for post processing. In some embodiments, the post processor 114 may generate one or more additional frames based on the frame. In some embodiments, the post processor 114 may execute other post processing functions on the frame.

In block 508, the system causes timed display of the post processed frame. In some embodiments, the swap chain adapter 126 may generate a third command to cause display of the post processed frame at a first time and a fourth command to cause display of at least one of the one or more additional frames at a second time that is after the first time. In some embodiments, the timing of each display may be assigned by the timing coordinator 124 providing instructions to the swap chain adapter 126. In some embodiments, the first command from the application 104 may be to render the frame and a following command from the application 104 may be to display the frame. The swap chain adapter 126 may intercept a third command from the application to display the frame and provide a fourth command to the swap chain 108 to display the frame based on a frame rate from a timing coordinator 124. The third command may include timing that is different than a timing identified by the timing coordinator 124. Therefore, the fourth command may be the third command adapted by the identified time.

The system may utilize processor circuitry to cause a graphics driver to perform first operations on a frame according to an updated frame packet. The updated frame packet may comprise a new command to a swap chain rather than perform second operations on the frame according to an original frame packet comprising an original command to the swap chain that is intercepted by the processor circuitry.

In some embodiments, the systems and methods described herein may be performed in conjunction with a simulation environment (e.g., NVIDIA's DriveSIM) using simulated data (e.g., simulated sensor data of simulated sensors of a virtual or simulated machine). For example, the application 104 may correspond to or display information from a simulation environment. For example, simulated sensor data and/or map data may be used to identify regions of interest (e.g., parking spaces) and sub-regions of interest (e.g., sub-regions of a parking space that includes a curb, wheel stop, etc.) within the simulation environment, and may use this information to perform operations (e.g., parking) associated with the virtual machine within the environment. These simulated operations may be used to test performance of the underlying algorithms, systems, and/or processes prior to deploying them in the real-world. In some instances, the simulation may be used to generate synthetic training data—e.g., training data including regions of interest and/or sub-regions of interest from within the simulation. The synthetic training data (in addition to or alternatively from real-world data) may then be processed to determine geometry and/or other information related to regions of interest, such as parking spaces or pallet delivery locations within a warehouse, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

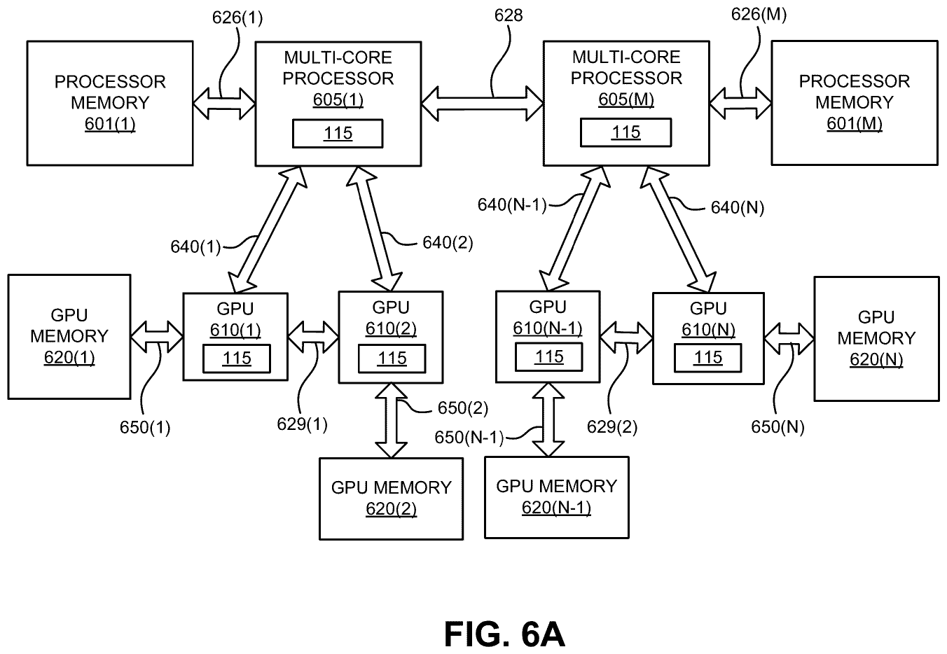

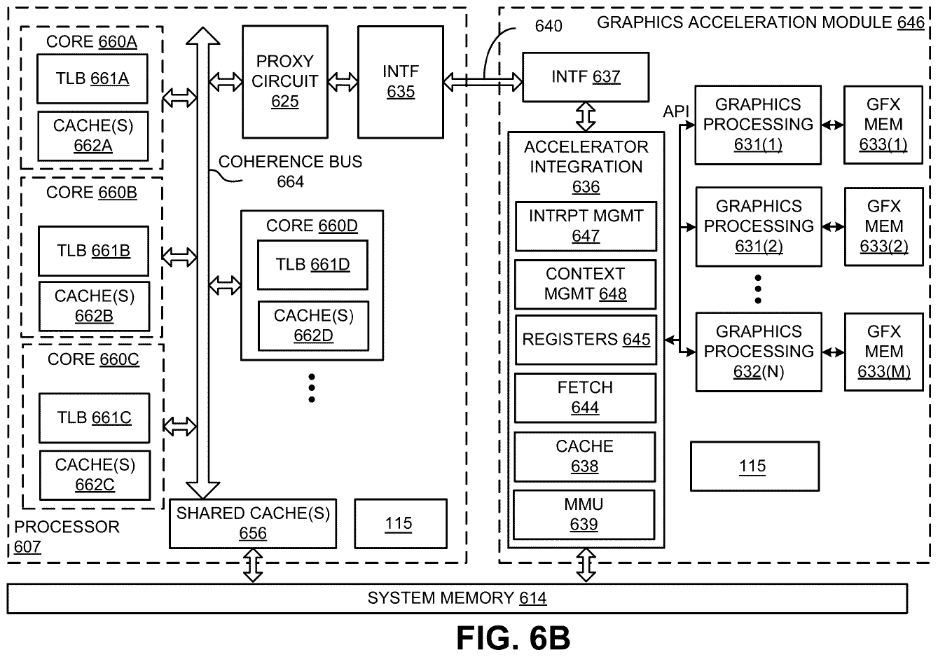

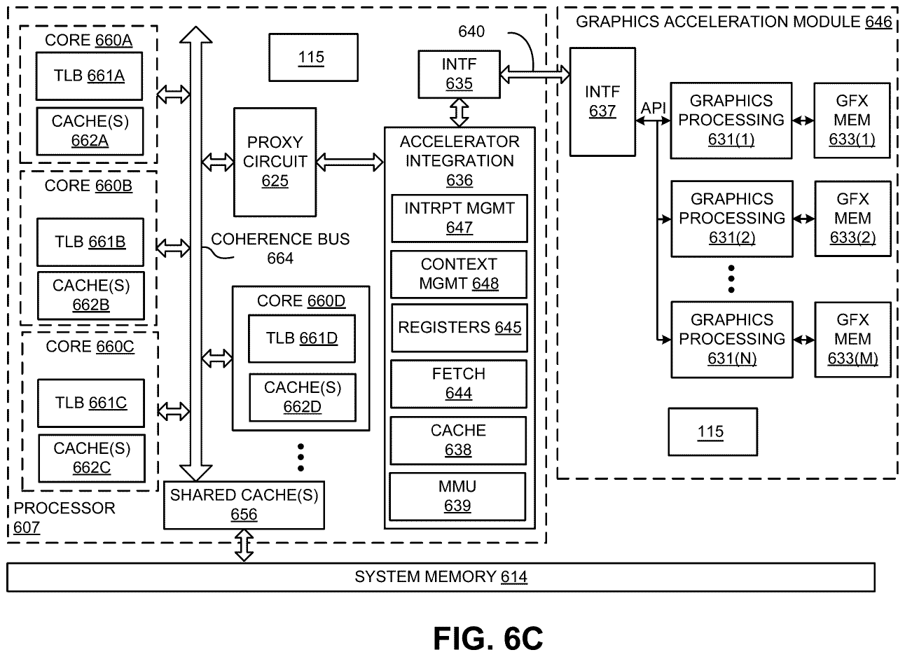

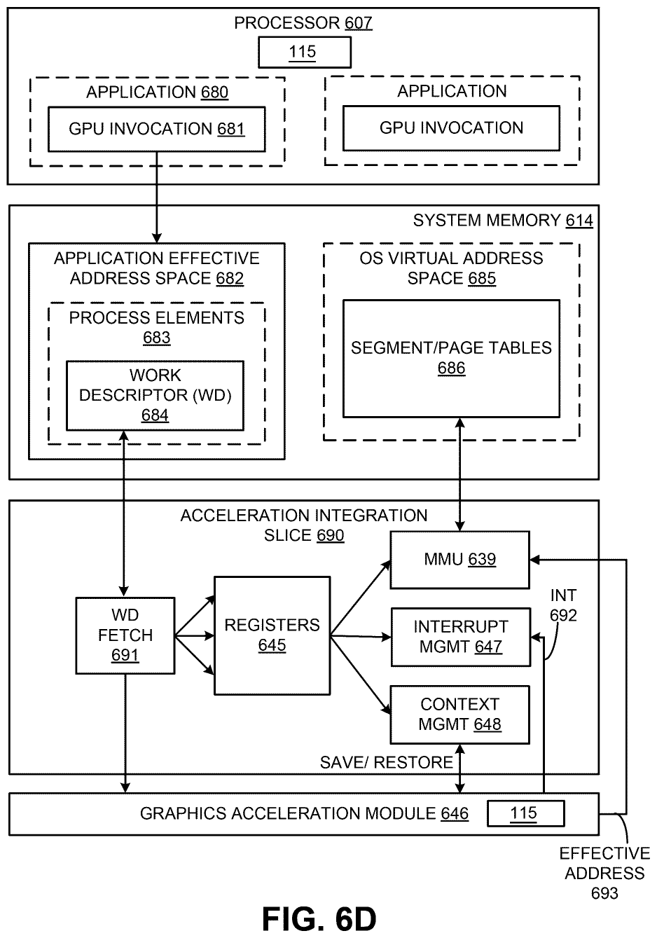

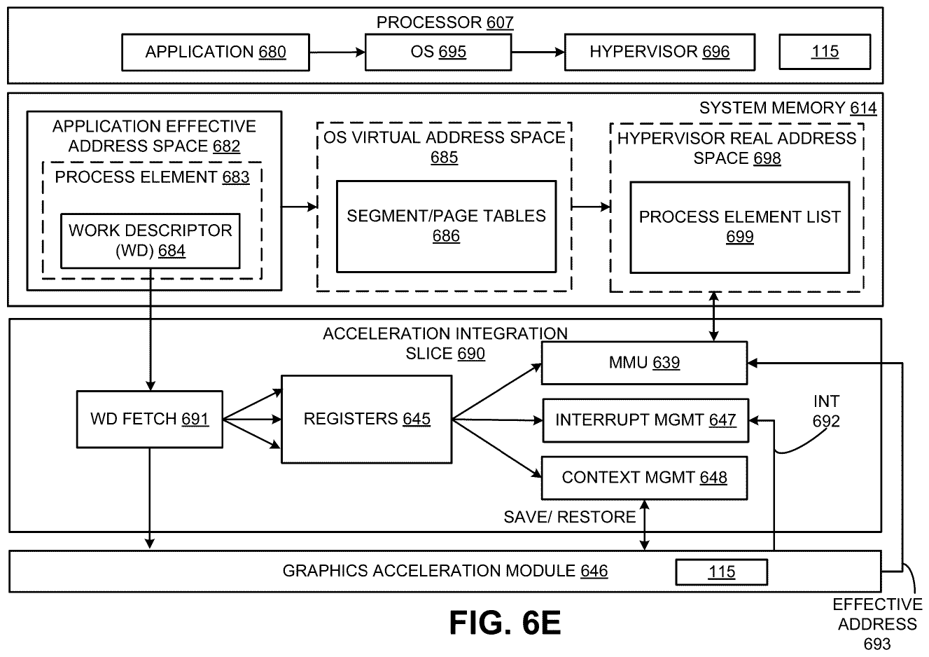

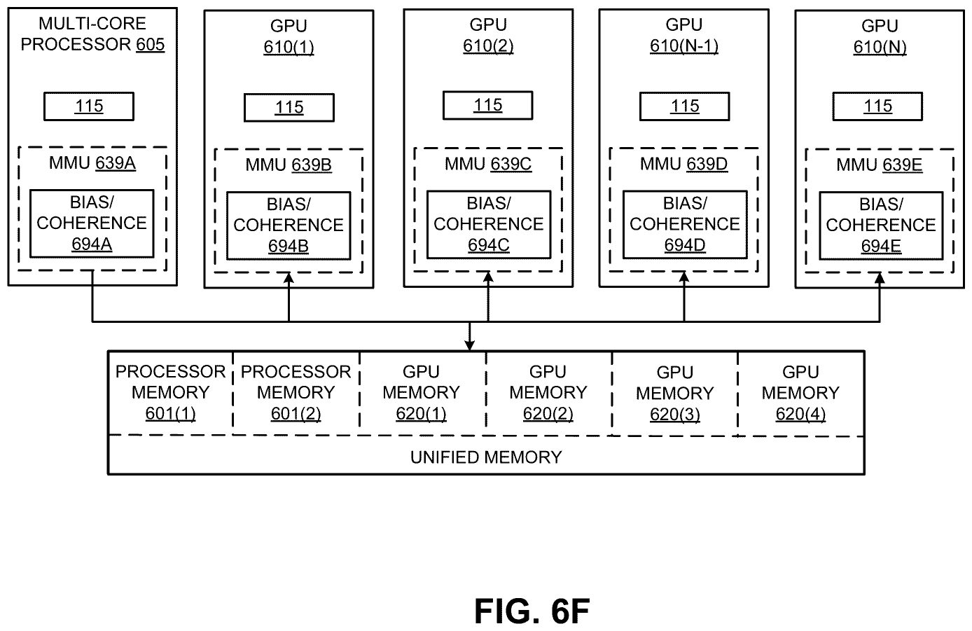

FIG. 6A illustrates an exemplary architecture in which a plurality of GPUs 610(1)-610(N) is communicatively coupled to a plurality of multi-core processors 605(1)-605(M) over high-speed links 640(1)-640(N) (e.g., buses, point-to-point interconnects, etc.). The architectre of FIG. 6A may be used to execute post processing and other computational tasks of the graphics driver 106 executing commands generated by the application 104 and the swap chain adapter 126 of FIG. 1. In at least one embodiment, high-speed links 640(1)-640(N) support a communication throughput of 4 GB/s, 30 GB/s, 80 GB/s or higher. In at least one embodiment, various interconnect protocols may be used including, but not limited to, PCIe 4.0 or 5.0 and NVLink 2.0. In various figures, “N” and “M” represent positive integers, values of which may be different from figure to figure.

In addition, and in at least one embodiment, two or more of GPUs 610 are interconnected over high-speed links 629(1)-629(2), which may be implemented using similar or different protocols/links than those used for high-speed links 640(1)-640(N). Similarly, two or more of multi-core processors 605 may be connected over a high-speed link 628 which may be symmetric multi-processor (SMP) buses operating at 20 GB/s, 30 GB/s, 120 GB/s or higher. Alternatively, all communication between various system components shown in FIG. 6A may be accomplished using similar protocols/links (e.g., over a common interconnection fabric).

In at least one embodiment, each multi-core processor 605 is communicatively coupled to a processor memory 601(1)-601(M), via memory interconnects 626(1)-626(M), respectively, and each GPU 610(1)-610(N) is communicatively coupled to GPU memory 620(1)-620(N) over GPU memory interconnects 650(1)-650(N), respectively. In at least one embodiment, memory interconnects 626 and 650 may utilize similar or different memory access technologies. By way of example, and not limitation, processor memories 601(1)-601(M) and GPU memories 620 may be volatile memories such as dynamic random access memories (DRAMs) (including stacked DRAMs), Graphics DDR SDRAM (GDDR) (e.g., GDDR5, GDDR6), or High Bandwidth Memory (HBM) and/or may be non-volatile memories such as 3D XPoint or Nano-Ram. In at least one embodiment, some portion of processor memories 601 may be volatile memory and another portion may be non-volatile memory (e.g., using a two-level memory (2 LM) hierarchy).

As described herein, although various multi-core processors 605 and GPUs 610 may be physically coupled to a particular memory 601, 620, respectively, and/or a unified memory architecture may be implemented in which a virtual system address space (also referred to as “effective address” space) is distributed among various physical memories. For example, processor memories 601(1)-601(M) may each comprise 64 GB of system memory address space and GPU memories 620(1)-620(N) may each comprise 32 GB of system memory address space resulting in a total of 256 GB addressable memory when M=2 and N=4. Other values for N and M are possible.

FIG. 6B illustrates additional details for an interconnection between a multi-core processor 607 and a graphics acceleration module 646 in accordance with one exemplary embodiment. The architectre of FIG. 6B may be used to execute post processing and other computational tasks of the graphics driver 106 executing commands generated by the application 104 and the swap chain adapter 126 of FIG. 1. In at least one embodiment, graphics acceleration module 646 may include one or more GPU chips integrated on a line card which is coupled to processor 607 via high-speed link 640 (e.g., a PCIe bus, NVLink, etc.). In at least one embodiment, graphics acceleration module 646 may alternatively be integrated on a package or chip with processor 607.

In at least one embodiment, processor 607 includes a plurality of cores 660A-660D, each with a translation lookaside buffer (“TLB”) 661A-661D and one or more caches 662A-662D. In at least one embodiment, cores 660A-660D may include various other components for executing instructions and processing data that are not illustrated. In at least one embodiment, caches 662A-662D may comprise Level 1 (L1) and Level 2 (L2) caches. In addition, one or more shared caches 656 may be included in caches 662A-662D and shared by sets of cores 660A-660D. For example, one embodiment of processor 607 includes 24 cores, each with its own L1 cache, twelve shared L2 caches, and twelve shared L3 caches. In this embodiment, one or more L2 and L3 caches are shared by two adjacent cores. In at least one embodiment, processor 607 and graphics acceleration module 646 connect with system memory 614, which may include processor memories 601(1)-601(M) of FIG. 6A.

In at least one embodiment, coherency is maintained for data and instructions stored in various caches 662A-662D, 656 and system memory 614 via inter-core communication over a coherence bus 664. In at least one embodiment, for example, each cache may have cache coherency logic/circuitry associated therewith to communicate to over coherence bus 664 in response to detected reads or writes to particular cache lines. In at least one embodiment, a cache snooping protocol is implemented over coherence bus 664 to snoop cache accesses.

In at least one embodiment, a proxy circuit 925 communicatively couples graphics acceleration module 646 to coherence bus 664, allowing graphics acceleration module 646 to participate in a cache coherence protocol as a peer of cores 660A-660D. In particular, in at least one embodiment, an interface 635 provides connectivity to proxy circuit 925 over high-speed link 640 and an interface 637 connects graphics acceleration module 646 to high-speed link 640.

In at least one embodiment, an accelerator integration circuit 636 provides cache management, memory access, context management, and interrupt management services on behalf of a plurality of graphics processing engines 631(1)-631(N) of graphics acceleration module 646. In at least one embodiment, graphics processing engines 631(1)-631(N) may each comprise a separate graphics processing unit (GPU). In at least one embodiment, graphics processing engines 631(1)-631(N) alternatively may comprise different types of graphics processing engines within a GPU, such as graphics execution units, media processing engines (e.g., video encoders/decoders), samplers, and blit engines. In at least one embodiment, graphics acceleration module 646 may be a GPU with a plurality of graphics processing engines 631(1)-631(N) or graphics processing engines 631(1)-631(N) may be individual GPUs integrated on a common package, line card, or chip.

In at least one embodiment, accelerator integration circuit 636 includes a memory management unit (MMU) 639 for performing various memory management functions such as virtual-to-physical memory translations (also referred to as effective-to-real memory translations) and memory access protocols for accessing system memory 614. In at least one embodiment, MMU 639 may also include a translation lookaside buffer (TLB) (not shown) for caching virtual/effective to physical/real address translations. In at least one embodiment, a cache 638 can store commands and data for efficient access by graphics processing engines 631(1)-631(N). In at least one embodiment, data stored in cache 638 and graphics memories 633(1)-633(M) is kept coherent with core caches 662A-662D, 656 and system memory 614, possibly using a fetch unit 644. As mentioned, this may be accomplished via proxy circuit 925 on behalf of cache 638 and memories 633(1)-633(M) (e.g., sending updates to cache 638 related to modifications/accesses of cache lines on processor caches 662A-662D, 656 and receiving updates from cache 638).

In at least one embodiment, a set of registers 645 store context data for threads executed by graphics processing engines 631(1)-631(N) and a context management circuit 648 manages thread contexts. For example, context management circuit 648 may perform save and restore operations to save and restore contexts of various threads during contexts switches (e.g., where a first thread is saved and a second thread is stored so that a second thread can be execute by a graphics processing engine). For example, on a context switch, context management circuit 648 may store current register values to a designated region in memory (e.g., identified by a context pointer). It may then restore register values when returning to a context. In at least one embodiment, an interrupt management circuit 647 receives and processes interrupts received from system devices.

In at least one embodiment, virtual/effective addresses from a graphics processing engine 631 are translated to real/physical addresses in system memory 614 by MMU 639. In at least one embodiment, accelerator integration circuit 636 supports multiple (e.g., 4, 8, 16) graphics accelerator modules 646 and/or other accelerator devices. In at least one embodiment, graphics accelerator module 646 may be dedicated to a single application executed on processor 607 or may be shared between multiple applications. In at least one embodiment, a virtualized graphics execution environment is presented in which resources of graphics processing engines 631(1)-631(N) are shared with multiple applications or virtual machines (VMs). In at least one embodiment, resources may be subdivided into “slices” which are allocated to different VMs and/or applications based on processing requirements and priorities associated with VMs and/or applications.

In at least one embodiment, accelerator integration circuit 636 performs as a bridge to a system for graphics acceleration module 646 and provides address translation and system memory cache services. In addition, in at least one embodiment, accelerator integration circuit 636 may provide virtualization facilities for a host processor to manage virtualization of graphics processing engines 631(1)-631(N), interrupts, and memory management.

In at least one embodiment, because hardware resources of graphics processing engines 631(1)-631(N) are mapped explicitly to a real address space seen by host processor 607, any host processor can address these resources directly using an effective address value. In at least one embodiment, one function of accelerator integration circuit 636 is physical separation of graphics processing engines 631(1)-631(N) so that they appear to a system as independent units.

In at least one embodiment, one or more graphics memories 633(1)-633(M) are coupled to each of graphics processing engines 631(1)-631(N), respectively and N=M. In at least one embodiment, graphics memories 633(1)-633(M) store instructions and data being processed by each of graphics processing engines 631(1)-631(N). In at least one embodiment, graphics memories 633(1)-633(M) may be volatile memories such as DRAMs (including stacked DRAMs), GDDR memory (e.g., GDDR5, GDDR6), or HBM, and/or may be non-volatile memories such as 3D XPoint or Nano-Ram.

In at least one embodiment, to reduce data traffic over high-speed link 640, biasing techniques can be used to ensure that data stored in graphics memories 633(1)-633(M) is data that will be used most frequently by graphics processing engines 631(1)-631(N) and preferably not used by cores 660A-660D (at least not frequently). Similarly, in at least one embodiment, a biasing mechanism attempts to keep data needed by cores (and preferably not graphics processing engines 631(1)-631(N)) within caches 662A-662D, 656 and system memory 614.

FIG. 6C illustrates another exemplary embodiment in which accelerator integration circuit 636 is integrated within processor 607. The architectre of FIG. 6C may be used to execute post processing and other computational tasks of the graphics driver 106 executing commands generated by the application 104 and the swap chain adapter 126 of FIG. 1. In this embodiment, graphics processing engines 631(1)-631(N) communicate directly over high-speed link 640 to accelerator integration circuit 636 via interface 637 and interface 635 (which, again, may be any form of bus or interface protocol). In at least one embodiment, accelerator integration circuit 636 may perform similar operations as those described with respect to FIG. 6B, but potentially at a higher throughput given its close proximity to coherence bus 664 and caches 662A-662D, 656. In at least one embodiment, an accelerator integration circuit supports different programming models including a dedicated-process programming model (no graphics acceleration module virtualization) and shared programming models (with virtualization), which may include programming models which are controlled by accelerator integration circuit 636 and programming models which are controlled by graphics acceleration module 646.

In at least one embodiment, graphics processing engines 631(1)-631(N) are dedicated to a single application or process under a single operating system. In at least one embodiment, a single application can funnel other application requests to graphics processing engines 631(1)-631(N), providing virtualization within a VM/partition.

In at least one embodiment, graphics processing engines 631(1)-631(N), may be shared by multiple VM/application partitions. In at least one embodiment, shared models may use a system hypervisor to virtualize graphics processing engines 631(1)-631(N) to allow access by each operating system. In at least one embodiment, for single-partition systems without a hypervisor, graphics processing engines 631(1)-631(N) are owned by an operating system. In at least one embodiment, an operating system can virtualize graphics processing engines 631(1)-631(N) to provide access to each process or application.

In at least one embodiment, graphics acceleration module 646 or an individual graphics processing engine 631(1)-631(N) selects a process element using a process handle. In at least one embodiment, process elements are stored in system memory 614 and are addressable using an effective address to real address translation technique described herein. In at least one embodiment, a process handle may be an implementation-specific value provided to a host process when registering its context with graphics processing engine 631(1)-631(N) (that is, calling system software to add a process element to a process element linked list). In at least one embodiment, a lower 16-bits of a process handle may be an offset of a process element within a process element linked list.

FIG. 6D illustrates an exemplary accelerator integration slice 690. The architectre of FIG. 6D may be used to execute post processing and other computational tasks of the graphics driver 106 executing commands generated by the application 104 and the swap chain adapter 126 of FIG. 1. In at least one embodiment, a “slice” comprises a specified portion of processing resources of accelerator integration circuit 636. In at least one embodiment, an application is effective address space 682 within system memory 614 stores process elements 683. In at least one embodiment, process elements 683 are stored in response to GPU invocations 681 from applications 680 executed on processor 607. In at least one embodiment, a process element 683 contains process state for corresponding application 680. In at least one embodiment, a work descriptor (WD) 684 contained in process element 683 can be a single job requested by an application or may contain a pointer to a queue of jobs. In at least one embodiment, WD 684 is a pointer to a job request queue in an application's effective address space 682.

In at least one embodiment, graphics acceleration module 646 and/or individual graphics processing engines 631(1)-631(N) can be shared by all or a subset of processes in a system. In at least one embodiment, an infrastructure for setting up process states and sending a WD 684 to a graphics acceleration module 646 to start a job in a virtualized environment may be included.

In at least one embodiment, a dedicated-process programming model is implementation-specific. In at least one embodiment, in this model, a single process owns graphics acceleration module 646 or an individual graphics processing engine 631. In at least one embodiment, when graphics acceleration module 646 is owned by a single process, a hypervisor initializes accelerator integration circuit 636 for an owning partition and an operating system initializes accelerator integration circuit 636 for an owning process when graphics acceleration module 646 is assigned.

In at least one embodiment, in operation, a WD fetch unit 691 in accelerator integration slice 690 fetches next WD 684, which includes an indication of work to be done by one or more graphics processing engines of graphics acceleration module 646. In at least one embodiment, data from WD 684 may be stored in registers 645 and used by MMU 639, interrupt management circuit 647 and/or context management circuit 648 as illustrated. For example, one embodiment of MMU 639 includes segment/page walk circuitry for accessing segment/page tables 686 within an OS virtual address space 685. In at least one embodiment, interrupt management circuit 647 may process interrupt events 692 received from graphics acceleration module 646. In at least one embodiment, when performing graphics operations, an effective address 693 generated by a graphics processing engine 631(1)-631(N) is translated to a real address by MMU 639.

In at least one embodiment, registers 645 are duplicated for each graphics processing engine 631(1)-631(N) and/or graphics acceleration module 646 and may be initialized by a hypervisor or an operating system. In at least one embodiment, each of these duplicated registers may be included in an accelerator integration slice 690. Exemplary registers that may be initialized by a hypervisor are shown in Table 1.

TABLE 1
Hypervisor Initialized Registers

| Register | |
|---|---|
| # | Description |
| 1 | Slice Control Register |
| 2 | Real Address (RA) Scheduled Processes Area Pointer |
| 3 | Authority Mask Override Register |
| 4 | Interrupt Vector Table Entry Offset |
| 5 | Interrupt Vector Table Entry Limit |
| 6 | State Register |
| 7 | Logical Partition ID |
| 8 | Real address (RA) Hypervisor Accelerator Utilization Record |
| | Pointer |
| 9 | Storage Description Register |

Exemplary registers that may be initialized by an operating system are shown in Table 2.

TABLE 2
Operating System Initialized Registers

| Register # | Description |
|---|---|
| 1 | Process and Thread Identification |
| 2 | Effective Address (EA) Context Save/Restore Pointer |
| 3 | Virtual Address (VA) Accelerator Utilization Record Pointer |
| 4 | Virtual Address (VA) Storage Segment Table Pointer |
| 5 | Authority Mask |
| 6 | Work descriptor |

In at least one embodiment, each WD 684 is specific to a particular graphics acceleration module 646 and/or graphics processing engines 631(1)-631(N). In at least one embodiment, it contains all information required by a graphics processing engine 631(1)-631(N) to do work, or it can be a pointer to a memory location where an application has set up a command queue of work to be completed.

FIG. 6E illustrates additional details for one exemplary embodiment of a shared model. The architectre of FIG. 6E may be used to execute post processing and other computational tasks of the graphics driver 106 executing commands generated by the application 104 and the swap chain adapter 126 of FIG. 1. This embodiment includes a hypervisor real address space 698 in which a process element list 699 is stored. In at least one embodiment, hypervisor real address space 698 is accessible via a hypervisor 696 which virtualizes graphics acceleration module engines for operating system 695.

In at least one embodiment, shared programming models allow for all or a subset of processes from all or a subset of partitions in a system to use a graphics acceleration module 646. In at least one embodiment, there are two programming models where graphics acceleration module 646 is shared by multiple processes and partitions, namely time-sliced shared and graphics directed shared.

In at least one embodiment, in this model, system hypervisor 696 owns graphics acceleration module 646 and makes its function available to all operating systems 695. In at least one embodiment, for a graphics acceleration module 646 to support virtualization by system hypervisor 696, graphics acceleration module 646 may adhere to certain requirements, such as (1) an application's job request must be autonomous (that is, state does not need to be maintained between jobs), or graphics acceleration module 646 must provide a context save and restore mechanism, (2) an application's job request is guaranteed by graphics acceleration module 646 to complete in a specified amount of time, including any translation faults, or graphics acceleration module 646 provides an ability to preempt processing of a job, and (3) graphics acceleration module 646 must be guaranteed fairness between processes when operating in a directed shared programming model.

In at least one embodiment, application 680 is required to make an operating system 695 system call with a graphics acceleration module type, a work descriptor (WD), an authority mask register (AMR) value, and a context save/restore area pointer (CSRP). In at least one embodiment, graphics acceleration module type describes a targeted acceleration function for a system call. In at least one embodiment, graphics acceleration module type may be a system-specific value. In at least one embodiment, WD is formatted specifically for graphics acceleration module 646 and can be in a form of a graphics acceleration module 646 command, an effective address pointer to a user-defined structure, an effective address pointer to a queue of commands, or any other data structure to describe work to be done by graphics acceleration module 646.

In at least one embodiment, an AMR value is an AMR state to use for a current process. In at least one embodiment, a value passed to an operating system is similar to an application setting an AMR. In at least one embodiment, if accelerator integration circuit 636 (not shown) and graphics acceleration module 646 implementations do not support a User Authority Mask Override Register (UAMOR), an operating system may apply a current UAMOR value to an AMR value before passing an AMR in a hypervisor call. In at least one embodiment, hypervisor 696 may optionally apply a current Authority Mask Override Register (AMOR) value before placing an AMR into process element 683. In at least one embodiment, CSRP is one of registers 645 containing an effective address of an area in an application's effective address space 682 for graphics acceleration module 646 to save and restore context state. In at least one embodiment, this pointer is optional if no state is required to be saved between jobs or when a job is preempted. In at least one embodiment, context save/restore area may be pinned system memory.

Upon receiving a system call, operating system 695 may verify that application 680 has registered and been given authority to use graphics acceleration module 646. In at least one embodiment, operating system 695 then calls hypervisor 696 with information shown in Table 3.

TABLE 3
OS to Hypervisor Call Parameters

| Parameter | |
|---|---|
| # | Description |
| 1 | A work descriptor (WD) |
| 2 | An Authority Mask Register (AMR) value (potentially |
| | masked) |
| 3 | An effective address (EA) Context Save/Restore Area |
| | Pointer (CSRP) |
| 4 | A process ID (PID) and optional thread ID (TID) |
| 5 | A virtual address (VA) accelerator utilization record |
| | pointer (AURP) |
| 6 | Virtual address of storage segment table pointer (SSTP) |
| 7 | A logical interrupt service number (LISN) |

In at least one embodiment, upon receiving a hypervisor call, hypervisor 696 verifies that operating system 695 has registered and been given authority to use graphics acceleration module 646. In at least one embodiment, hypervisor 696 then puts process element 683 into a process element linked list for a corresponding graphics acceleration module 646 type. In at least one embodiment, a process element may include information shown in Table 4.

TABLE 4
Process Element Information

| Element | |
|---|---|
| # | Description |
| 1 | A work descriptor (WD) |
| 2 | An Authority Mask Register (AMR) value (potentially |
| | masked). |
| 3 | An effective address (EA) Context Save/Restore Area |
| | Pointer (CSRP) |
| 4 | A process ID (PID) and optional thread ID (TID) |
| 5 | A virtual address (VA) accelerator utilization record |
| | pointer (AURP) |
| 6 | Virtual address of storage segment table pointer (SSTP) |
| 7 | A logical interrupt service number (LISN) |
| 8 | Interrupt vector table, derived from hypervisor call parameters |
| 9 | A state register (SR) value |
| 10 | A logical partition ID (LPID) |
| 11 | A real address (RA) hypervisor accelerator utilization record |
| | pointer |
| 12 | Storage Descriptor Register (SDR) |

In at least one embodiment, hypervisor initializes a plurality of accelerator integration slice 690 registers 645.

As illustrated in FIG. 6F, in at least one embodiment, a unified memory is used, addressable via a common virtual memory address space used to access physical processor memories 601(1)-601(N) and GPU memories 620(1)-620(N). The architectre of FIG. 6F may be used to execute post processing and other computational tasks of the graphics driver 106 executing commands generated by the application 104 and the swap chain adapter 126 of FIG. 1. In this implementation, operations executed on GPUs 610(1)-610(N) utilize a same virtual/effective memory address space to access processor memories 601(1)-601(M) and vice versa, thereby simplifying programmability. In at least one embodiment, a first portion of a virtual/effective address space is allocated to processor memory 601(1), a second portion to second processor memory 601(N), a third portion to GPU memory 620(1), and so on. In at least one embodiment, an entire virtual/effective memory space (sometimes referred to as an effective address space) is thereby distributed across each of processor memories 601 and GPU memories 620, allowing any processor or GPU to access any physical memory with a virtual address mapped to that memory.

In at least one embodiment, bias/coherence management circuitry 694A-694E within one or more of MMUs 636A-636E ensures cache coherence between caches of one or more host processors (e.g., 605) and GPUs 610 and implements biasing techniques indicating physical memories in which certain types of data should be stored. In at least one embodiment, while multiple instances of bias/coherence management circuitry 694A-694E are illustrated in FIG. 6F, bias/coherence circuitry may be implemented within an MMU of one or more host processors 605 and/or within accelerator integration circuit 636.

One embodiment allows GPU memories 620 to be mapped as part of system memory, and accessed using shared virtual memory (SVM) technology, but without suffering performance drawbacks associated with full system cache coherence. In at least one embodiment, an ability for GPU memories 620 to be accessed as system memory without onerous cache coherence overhead provides a beneficial operating environment for GPU offload. In at least one embodiment, this arrangement allows software of host processor 605 to setup operands and access computation results, without overhead of tradition I/O DMA data copies. In at least one embodiment, such traditional copies involve driver calls, interrupts and memory mapped I/O (MMIO) accesses that are all inefficient relative to simple memory accesses. In at least one embodiment, an ability to access GPU memories 620 without cache coherence overheads can be critical to execution time of an offloaded computation. In at least one embodiment, in cases with substantial streaming write memory traffic, for example, cache coherence overhead can significantly reduce an effective write bandwidth seen by a GPU 610. In at least one embodiment, efficiency of operand setup, efficiency of results access, and efficiency of GPU computation may play a role in determining effectiveness of a GPU offload.

In at least one embodiment, selection of GPU bias and host processor bias is driven by a bias tracker data structure. In at least one embodiment, a bias table may be used, for example, which may be a page-granular structure (e.g., controlled at a granularity of a memory page) that includes 1 or 2 bits per GPU-attached memory page. In at least one embodiment, a bias table may be implemented in a stolen memory range of one or more GPU memories 620, with or without a bias cache in a GPU 610 (e.g., to cache frequently/recently used entries of a bias table). Alternatively, in at least one embodiment, an entire bias table may be maintained within a GPU.

In at least one embodiment, a bias table entry associated with each access to a GPU attached memory 620 is accessed prior to actual access to a GPU memory, causing following operations. In at least one embodiment, local requests from a GPU 610 that find their page in GPU bias are forwarded directly to a corresponding GPU memory 620. In at least one embodiment, local requests from a GPU that find their page in host bias are forwarded to processor 605 (e.g., over a high-speed link as described herein). In at least one embodiment, requests from processor 605 that find a requested page in host processor bias complete a request like a normal memory read. Alternatively, requests directed to a GPU-biased page may be forwarded to a GPU 610. In at least one embodiment, a GPU may then transition a page to a host processor bias if it is not currently using a page. In at least one embodiment, a bias state of a page can be changed either by a software-based mechanism, a hardware-assisted software-based mechanism, or, for a limited set of cases, a purely hardware-based mechanism.

In at least one embodiment, one mechanism for changing bias state employs an API call (e.g., OpenCL), which, in turn, calls a GPU's device driver which, in turn, sends a message (or enqueues a command descriptor) to a GPU directing it to change a bias state and, for some transitions, perform a cache flushing operation in a host. In at least one embodiment, a cache flushing operation is used for a transition from host processor 605 bias to GPU bias, but is not for an opposite transition.

In at least one embodiment, cache coherency is maintained by temporarily rendering GPU-biased pages uncacheable by host processor 605. In at least one embodiment, to access these pages, processor 605 may request access from GPU 610, which may or may not grant access right away. In at least one embodiment, thus, to reduce communication between processor 605 and GPU 610 it is beneficial to ensure that GPU-biased pages are those which are required by a GPU but not host processor 605 and vice versa.

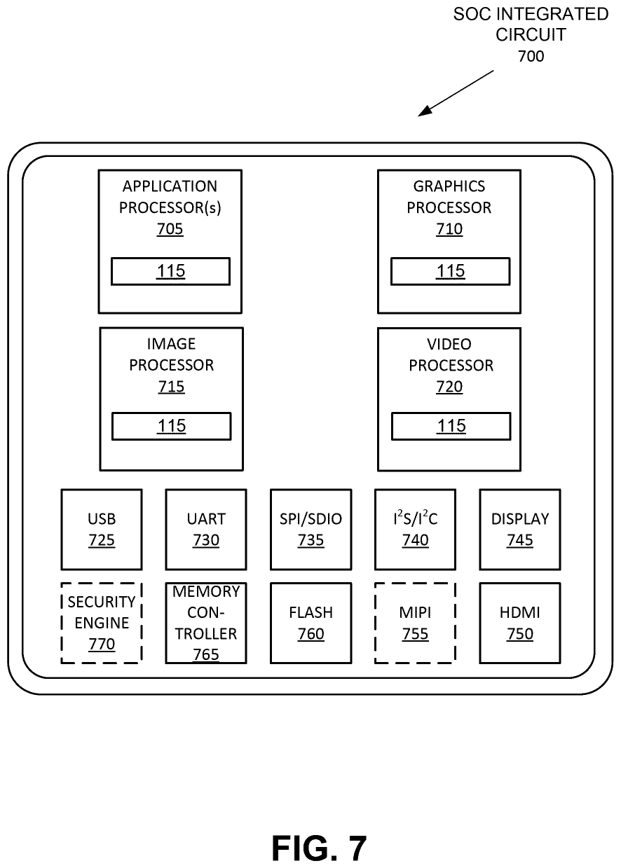

FIG. 7 illustrates exemplary integrated circuits and associated graphics processors that may be fabricated using one or more IP cores, according to various embodiments described herein. The graphics processors of FIG. 7 may be used to execute post processing and other computational tasks of the graphics driver 106 executing commands generated by the application 104 and the swap chain adapter 126 of FIG. 1. In addition to what is illustrated, other logic and circuits may be included in at least one embodiment, including additional graphics processors/cores, peripheral interface controllers, or general-purpose processor cores.

FIG. 7 is a block diagram illustrating an exemplary system on a chip integrated circuit 700 that may be fabricated using one or more IP cores, according to at least one embodiment. In at least one embodiment, integrated circuit 700 includes one or more application processor(s) 705 (e.g., CPUs), at least one graphics processor 710, and may additionally include an image processor 715 and/or a video processor 720, any of which may be a modular IP core. In at least one embodiment, integrated circuit 700 includes peripheral or bus logic including a USB controller 725, a UART controller 730, an SPI/SDIO controller 735, and an I²2S/I²2C controller 740. In at least one embodiment, integrated circuit 700 can include a display device 745 coupled to one or more of a high-definition multimedia interface (HDMI) controller 750 and a mobile industry processor interface (MIPI) display interface 755. In at least one embodiment, storage may be provided by a flash memory subsystem 760 including flash memory and a flash memory controller. In at least one embodiment, a memory interface may be provided via a memory controller 765 for access to SDRAM or SRAM memory devices. In at least one embodiment, some integrated circuits additionally include an embedded security engine 770.

Inference and/or training logic 115 are used to perform inferencing and/or training operations associated with one or more embodiments. In at least one embodiment, inference and/or training logic 115 may be used in integrated circuit 700 for inferencing or predicting operations based, at least in part, on weight parameters calculated using neural network training operations, neural network functions and/or architectures, or neural network use cases described herein.

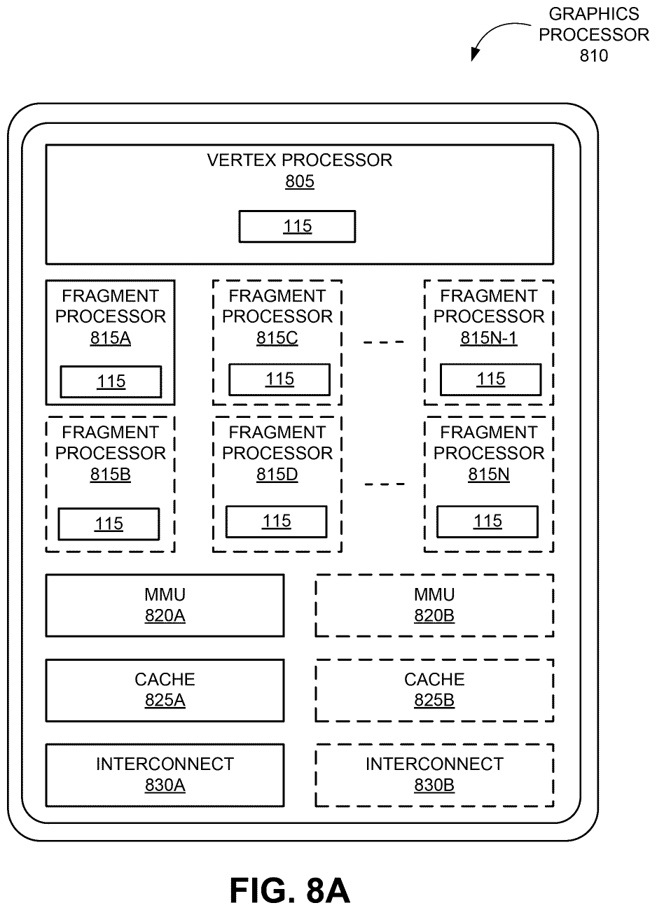

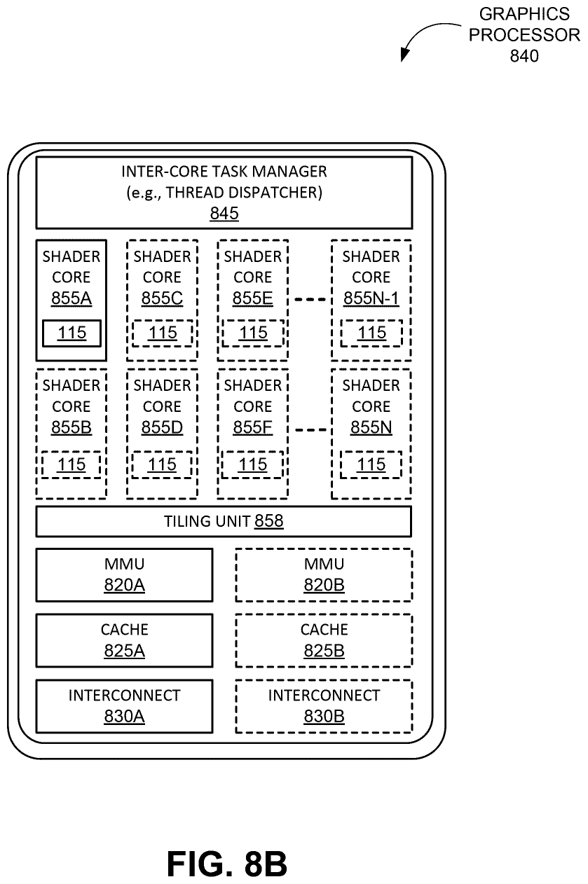

FIGS. 8A-8B illustrate exemplary integrated circuits and associated graphics processors that may be fabricated using one or more IP cores, according to various embodiments described herein. The graphics processors of FIGS. 8A-8B may be used to execute post processing and other computational tasks of the graphics driver 106 executing commands generated by the application 104 and the swap chain adapter 126 of FIG. 1. In addition to what is illustrated, other logic and circuits may be included in at least one embodiment, including additional graphics processors/cores, peripheral interface controllers, or general-purpose processor cores.

FIGS. 8A-8B are block diagrams illustrating exemplary graphics processors for use within an SoC, according to embodiments described herein. FIG. 8A illustrates an exemplary graphics processor 810 of a system on a chip integrated circuit that may be fabricated using one or more IP cores, according to at least one embodiment. FIG. 8B illustrates an additional exemplary graphics processor 840 of a system on a chip integrated circuit that may be fabricated using one or more IP cores, according to at least one embodiment. In at least one embodiment, graphics processor 810 of FIG. 8A is a low power graphics processor core. In at least one embodiment, graphics processor 840 of FIG. 8B is a higher performance graphics processor core. In at least one embodiment, each of graphics processors 810, 840 can be variants of graphics processor 710 of FIG. 7.

In at least one embodiment, graphics processor 810 includes a vertex processor 805 and one or more fragment processor(s) 815A-815N (e.g., 815A, 815B, 815C, 815D, through 815N-1, and 815N). In at least one embodiment, graphics processor 810 can execute different shader programs via separate logic, such that vertex processor 805 is optimized to execute operations for vertex shader programs, while one or more fragment processor(s) 815A-815N execute fragment (e.g., pixel) shading operations for fragment or pixel shader programs. In at least one embodiment, vertex processor 805 performs a vertex processing stage of a 3D graphics pipeline and generates primitives and vertex data. In at least one embodiment, fragment processor(s) 815A-815N use primitive and vertex data generated by vertex processor 805 to produce a framebuffer that is displayed on a display device. In at least one embodiment, fragment processor(s) 815A-815N are optimized to execute fragment shader programs as provided for in an OpenGL API, which may be used to perform similar operations as a pixel shader program as provided for in a Direct 3D API.

In at least one embodiment, graphics processor 810 additionally includes one or more memory management units (MMUs) 820A-820B, cache(s) 825A-825B, and circuit interconnect(s) 830A-830B. In at least one embodiment, one or more MMU(s) 820A-820B provide for virtual to physical address mapping for graphics processor 810, including for vertex processor 805 and/or fragment processor(s) 815A-815N, which may reference vertex or image/texture data stored in memory, in addition to vertex or image/texture data stored in one or more cache(s) 825A-825B. In at least one embodiment, one or more MMU(s) 820A-820B may be synchronized with other MMUs within a system, including one or more MMUs associated with one or more application processor(s) 705, image processors 715, and/or video processors 720 of FIG. 7, such that each processor 705-720 can participate in a shared or unified virtual memory system. In at least one embodiment, one or more circuit interconnect(s) 830A-830B enable graphics processor 810 to interface with other IP cores within SoC, either via an internal bus of SoC or via a direct connection.

In at least one embodiment, graphics processor 840 includes one or more shader core(s) 855A-855N (e.g., 855A, 855B, 855C, 855D, 855E, 855F, through 855N−1, and 855N) as shown in FIG. 8B, which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 840 includes an inter-core task manager 845, which acts as a thread dispatcher to dispatch execution threads to one or more shader cores 855A-855N and a tiling unit 858 to accelerate tiling operations for tile-based rendering, in which rendering operations for a scene are subdivided in image space, for example to exploit local spatial coherence within a scene or to optimize use of internal caches.

Inference and/or training logic 115 are used to perform inferencing and/or training operations associated with one or more embodiments. In at least one embodiment, inference and/or training logic 115 may be used in integrated circuit 8A and/or 8B for inferencing or predicting operations based, at least in part, on weight parameters calculated using neural network training operations, neural network functions and/or architectures, or neural network use cases described herein.

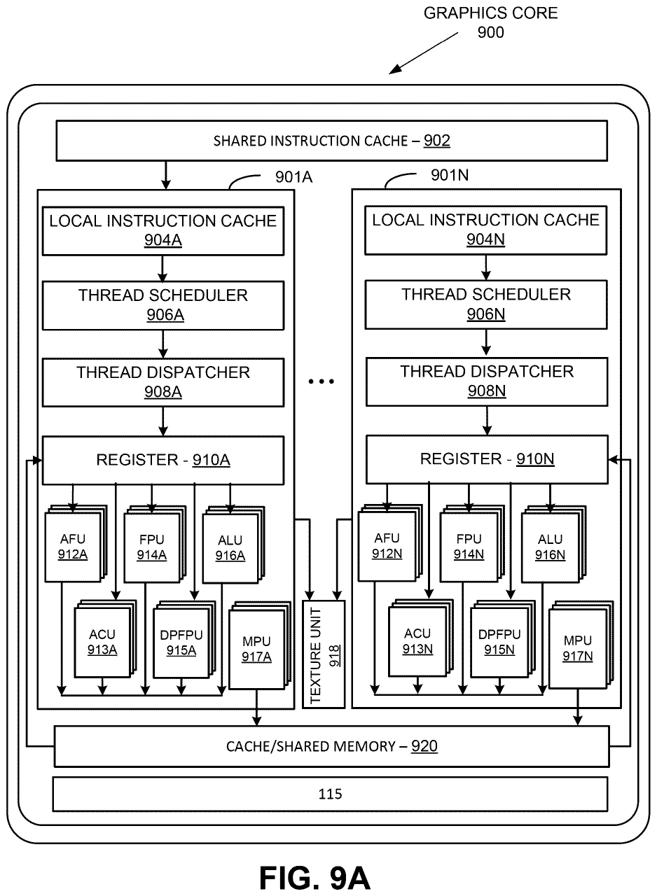

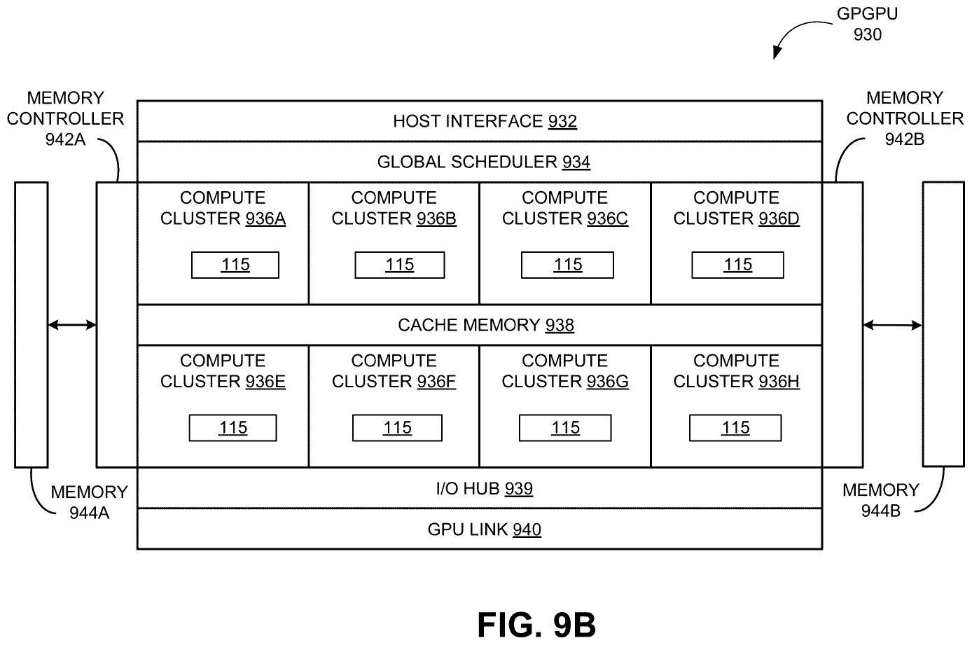

FIGS. 9A-9B illustrate additional exemplary graphics processor logic according to embodiments described herein. The graphics processors of FIGS. 9A-9B may be used to execute post processing and other computational tasks of the graphics driver 106 executing commands generated by the application 104 and the swap chain adapter 126 of FIG. 1. FIG. 9A illustrates a graphics core 900 that may be included within graphics processor 710 of FIG. 7, in at least one embodiment, and may be a unified shader core 855A-855N as in FIG. 8B in at least one embodiment. FIG. 9B illustrates a highly-parallel general-purpose graphics processing unit (“GPGPU”) 930 suitable for deployment on a multi-chip module in at least one embodiment.

In at least one embodiment, graphics core 900 includes a shared instruction cache 902, a texture unit 918, and a cache/shared memory 920 that are common to execution resources within graphics core 900. In at least one embodiment, graphics core 900 can include multiple slices 901A-901N or a partition for each core, and a graphics processor can include multiple instances of graphics core 900. In at least one embodiment, slices 901A-901N can include support logic including a local instruction cache 904A-904N, a thread scheduler 906A-906N, a thread dispatcher 908A-908N, and a set of registers 910A-910N. In at least one embodiment, slices 901A-901N can include a set of additional function units (AFUs 99A-912N), floating-point units (FPUs 914A-914N), integer arithmetic logic units (ALUs 916A-916N), address computational units (ACUs 913A-913N), double-precision floating-point units (DPFPUs 915A-915N), and matrix processing units (MPUs 917A-917N).

In at least one embodiment, FPUs 914A-914N can perform single-precision (32-bit) and half-precision (16-bit) floating point operations, while DPFPUs 915A-915N perform double precision (64-bit) floating point operations. In at least one embodiment, ALUs 916A-916N can perform variable precision integer operations at 8-bit, 16-bit, and 32-bit precision, and can be configured for mixed precision operations. In at least one embodiment, MPUs 917A-917N can also be configured for mixed precision matrix operations, including half-precision floating point and 8-bit integer operations. In at least one embodiment, MPUs 917-917N can perform a variety of matrix operations to accelerate machine learning application frameworks, including enabling support for accelerated general matrix to matrix multiplication (GEMM). In at least one embodiment, AFUs 99A-912N can perform additional logic operations not supported by floating-point or integer units, including trigonometric operations (e.g., sine, cosine, etc.).

Inference and/or training logic 115 are used to perform inferencing and/or training operations associated with one or more embodiments. In at least one embodiment, inference and/or training logic 115 may be used in graphics core 900 for inferencing or predicting operations based, at least in part, on weight parameters calculated using neural network training operations, neural network functions and/or architectures, or neural network use cases described herein.

FIG. 9B illustrates a general-purpose processing unit (GPGPU) 930 that can be configured to enable highly-parallel compute operations to be performed by an array of graphics processing units, in at least one embodiment. In at least one embodiment, GPGPU 930 can be linked directly to other instances of GPGPU 930 to create a multi-GPU cluster to improve training speed for deep neural networks. In at least one embodiment, GPGPU 930 includes a host interface 932 to enable a connection with a host processor. In at least one embodiment, host interface 932 is a PCI Express interface. In at least one embodiment, host interface 932 can be a vendor-specific communications interface or communications fabric. In at least one embodiment, GPGPU 930 receives commands from a host processor and uses a global scheduler 934 to distribute execution threads associated with those commands to a set of compute clusters 936A-936H. In at least one embodiment, compute clusters 936A-936H share a cache memory 938. In at least one embodiment, cache memory 938 can serve as a higher-level cache for cache memories within compute clusters 936A-936H.

In at least one embodiment, GPGPU 930 includes memory 944A-944B coupled with compute clusters 936A-936H via a set of memory controllers 942A-942B. In at least one embodiment, memory 944A-944B can include various types of memory devices including dynamic random access memory (DRAM) or graphics random access memory, such as synchronous graphics random access memory (SGRAM), including graphics double data rate (GDDR) memory.

In at least one embodiment, compute clusters 936A-936H each include a set of graphics cores, such as graphics core 900 of FIG. 9A, which can include multiple types of integer and floating point logic units that can perform computational operations at a range of precisions including suited for machine learning computations. For example, in at least one embodiment, at least a subset of floating point units in each of compute clusters 936A-936H can be configured to perform 16-bit or 32-bit floating point operations, while a different subset of floating point units can be configured to perform 64-bit floating point operations.

In at least one embodiment, multiple instances of GPGPU 930 can be configured to operate as a compute cluster. In at least one embodiment, communication used by compute clusters 936A-936H for synchronization and data exchange varies across embodiments. In at least one embodiment, multiple instances of GPGPU 930 communicate over host interface 932. In at least one embodiment, GPGPU 930 includes an I/O hub 939 that couples GPGPU 930 with a GPU link 940 that enables a direct connection to other instances of GPGPU 930. In at least one embodiment, GPU link 940 is coupled to a dedicated GPU-to-GPU bridge that enables communication and synchronization between multiple instances of GPGPU 930. In at least one embodiment, GPU link 940 couples with a high-speed interconnect to transmit and receive data to other GPGPUs or parallel processors. In at least one embodiment, multiple instances of GPGPU 930 are located in separate data processing systems and communicate via a network device that is accessible via host interface 932. In at least one embodiment GPU link 940 can be configured to enable a connection to a host processor in addition to or as an alternative to host interface 932.

In at least one embodiment, GPGPU 930 can be configured to train neural networks. In at least one embodiment, GPGPU 930 can be used within an inferencing platform. In at least one embodiment, in which GPGPU 930 is used for inferencing, GPGPU 930 may include fewer compute clusters 936A-936H relative to when GPGPU 930 is used for training a neural network. In at least one embodiment, memory technology associated with memory 944A-944B may differ between inferencing and training configurations, with higher bandwidth memory technologies devoted to training configurations. In at least one embodiment, an inferencing configuration of GPGPU 930 can support inferencing specific instructions. For example, in at least one embodiment, an inferencing configuration can provide support for one or more 8-bit integer dot product instructions, which may be used during inferencing operations for deployed neural networks.

Inference and/or training logic 115 are used to perform inferencing and/or training operations associated with one or more embodiments. In at least one embodiment, inference and/or training logic 115 may be used in GPGPU 930 for inferencing or predicting operations based, at least in part, on weight parameters calculated using neural network training operations, neural network functions and/or architectures, or neural network use cases described herein.

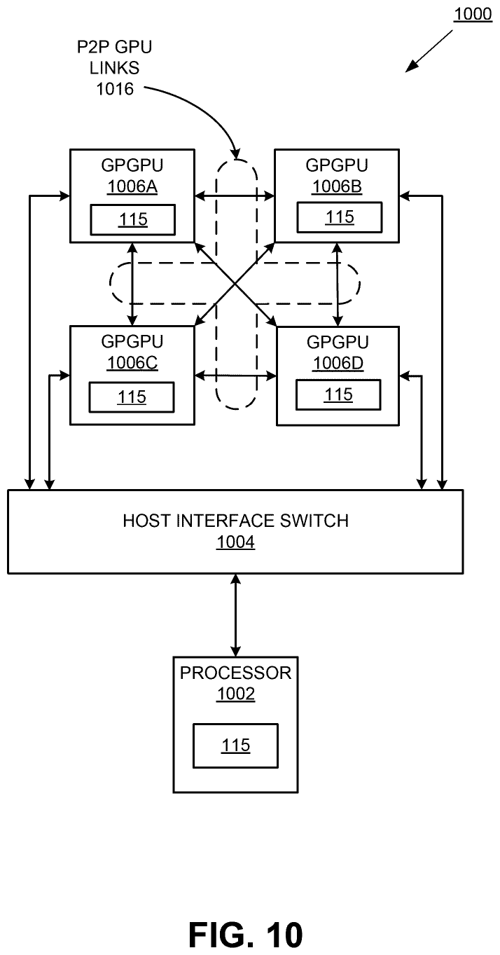

FIG. 10 illustrates a multi-GPU computing system 1000, according to at least one embodiment. The multi-GPU computing system 1000 of FIG. 10 may be used to execute post processing and other computational tasks of the graphics driver 106 executing commands generated by the application 104 and the swap chain adapter 126 of FIG. 1. In at least one embodiment, multi-GPU computing system 1000 can include a processor 1002 coupled to multiple general purpose graphics processing units (GPGPUs) 1006A-D via a host interface switch 1004. In at least one embodiment, host interface switch 1004 is a PCI express switch device that couples processor 1002 to a PCI express bus over which processor 1002 can communicate with GPGPUs 1006A-D. In at least one embodiment, GPGPUs 1006A-D can interconnect via a set of high-speed point-to-point GPU-to-GPU links 1016. In at least one embodiment, GPU-to-GPU links 1016 connect to each of GPGPUs 1006A-D via a dedicated GPU link. In at least one embodiment, P2P GPU links 1016 enable direct communication between each of GPGPUs 1006A-D without requiring communication over host interface bus 1004 to which processor 1002 is connected. In at least one embodiment, with GPU-to-GPU traffic directed to P2P GPU links 1016, host interface bus 1004 remains available for system memory access or to communicate with other instances of multi-GPU computing system 1000, for example, via one or more network devices. While in at least one embodiment GPGPUs 1006A-D connect to processor 1002 via host interface switch 1004, in at least one embodiment processor 1002 includes direct support for P2P GPU links 1016 and can connect directly to GPGPUs 1006A-D.

Inference and/or training logic 115 are used to perform inferencing and/or training operations associated with one or more embodiments. In at least one embodiment, inference and/or training logic 115 may be used in multi-GPU computing system 1000 for inferencing or predicting operations based, at least in part, on weight parameters calculated using neural network training operations, neural network functions and/or architectures, or neural network use cases described herein.

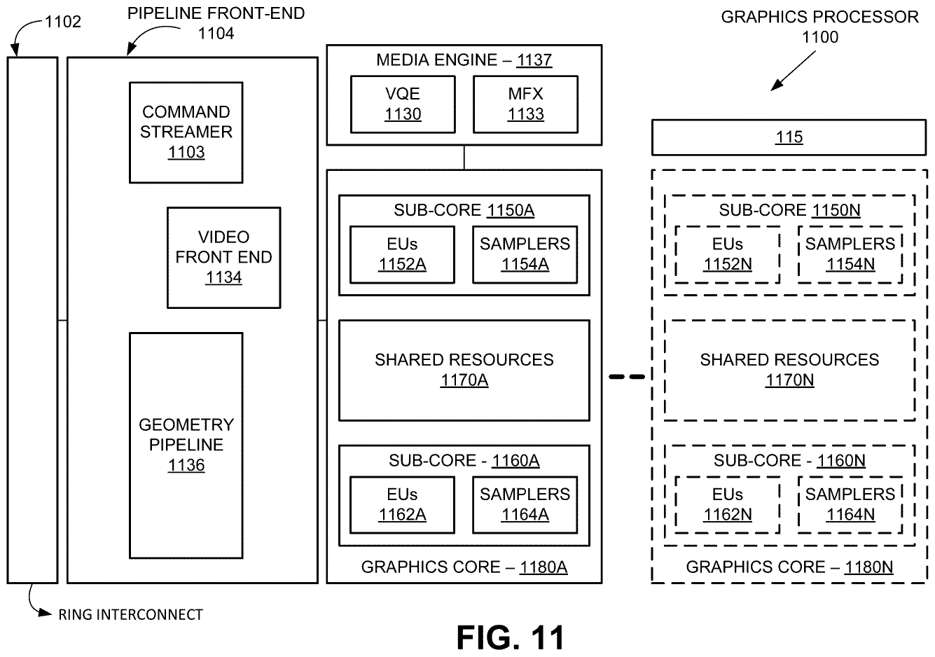

FIG. 11 is a block diagram of a graphics processor 1100, according to at least one embodiment. The graphics processors of FIG. 11 may be used to execute post processing and other computational tasks of the graphics driver 106 executing commands generated by the application 104 and the swap chain adapter 126 of FIG. 1. In at least one embodiment, graphics processor 1100 includes a ring interconnect 1102, a pipeline front-end 1104, a media engine 1137, and graphics cores 1180A-1180N. In at least one embodiment, ring interconnect 1102 couples graphics processor 1100 to other processing units, including other graphics processors or one or more general-purpose processor cores. In at least one embodiment, graphics processor 1100 is one of many processors integrated within a multi-core processing system.

In at least one embodiment, graphics processor 1100 receives batches of commands via ring interconnect 1102. In at least one embodiment, incoming commands are interpreted by a command streamer 1103 in pipeline front-end 1104. In at least one embodiment, graphics processor 1100 includes scalable execution logic to perform 3D geometry processing and media processing via graphics core(s) 1180A-1180N. In at least one embodiment, for 3D geometry processing commands, command streamer 1103 supplies commands to geometry pipeline 1136. In at least one embodiment, for at least some media processing commands, command streamer 1103 supplies commands to a video front end 1134, which couples with media engine 1137. In at least one embodiment, media engine 1137 includes a Video Quality Engine (VQE) 1130 for video and image post-processing and a multi-format encode/decode (MFX) 1133 engine to provide hardware-accelerated media data encoding and decoding. In at least one embodiment, geometry pipeline 1136 and media engine 1137 each generate execution threads for thread execution resources provided by at least one graphics core 1180.

In at least one embodiment, graphics processor 1100 includes scalable thread execution resources featuring graphics cores 1180A-1180N (which can be modular and are sometimes referred to as core slices), each having multiple sub-cores 1150A-50N, 1160A-1160N (sometimes referred to as core sub-slices). In at least one embodiment, graphics processor 1100 can have any number of graphics cores 1180A. In at least one embodiment, graphics processor 1100 includes a graphics core 1180A having at least a first sub-core 1150A and a second sub-core 1160A. In at least one embodiment, graphics processor 1100 is a low power processor with a single sub-core (e.g., 1150A). In at least one embodiment, graphics processor 1100 includes multiple graphics cores 1180A-1180N, each including a set of first sub-cores 1150A-1150N and a set of second sub-cores 1160A-1160N. In at least one embodiment, each sub-core in first sub-cores 1150A-1150N includes at least a first set of execution units 1152A-1152N and media/texture samplers 1154A-1154N. In at least one embodiment, each sub-core in second sub-cores 1160A-1160N includes at least a second set of execution units 1162A-1162N and samplers 1164A-1164N. In at least one embodiment, each sub-core 1150A-1150N, 1160A-1160N shares a set of shared resources 1170A-1170N. In at least one embodiment, shared resources include shared cache memory and pixel operation logic.

Inference and/or training logic 115 are used to perform inferencing and/or training operations associated with one or more embodiments. In at least one embodiment, inference and/or training logic 115 may be used in graphics processor 1100 for inferencing or predicting operations based, at least in part, on weight parameters calculated using neural network training operations, neural network functions and/or architectures, or neural network use cases described herein.

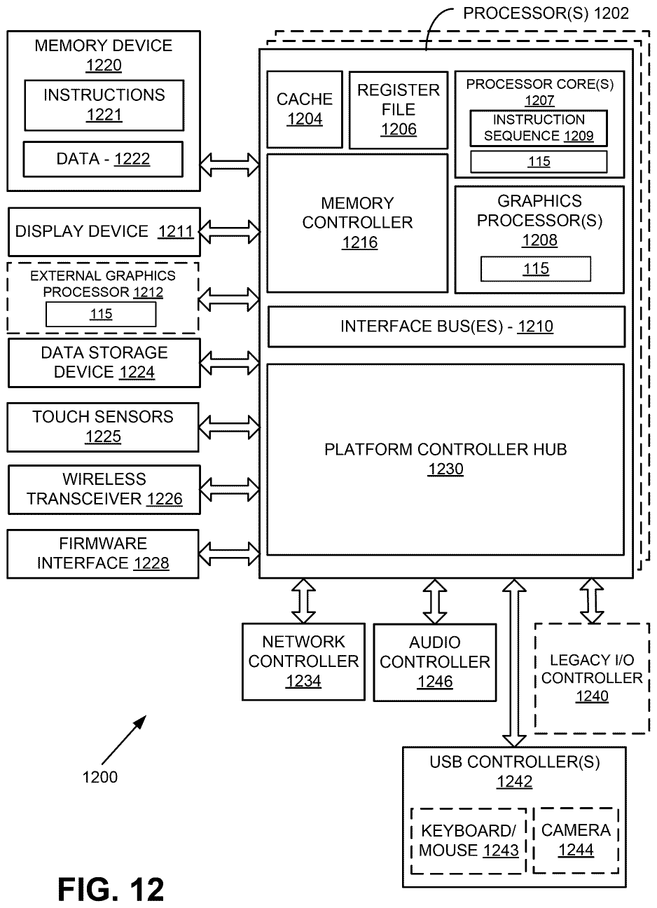

FIG. 12 is a block diagram of a processing system, according to at least one embodiment. The processing system of FIG. 12 may be used to execute post processing and other computational tasks of the graphics driver 106 executing commands generated by the application 104 and the swap chain adapter 126 of FIG. 1. In at least one embodiment, system 1200 includes one or more processors 1202 and one or more graphics processors 1208, and may be a single processor desktop system, a multiprocessor workstation system, or a server system having a large number of processors 1202 or processor cores 1207. In at least one embodiment, system 1200 is a processing platform incorporated within a system-on-a-chip (SoC) integrated circuit for use in mobile, handheld, or embedded devices.

In at least one embodiment, system 1200 can include, or be incorporated within a server-based gaming platform, a game console, including a game and media console, a mobile gaming console, a handheld game console, or an online game console. In at least one embodiment, system 1200 is a mobile phone, a smart phone, a tablet computing device or a mobile Internet device. In at least one embodiment, processing system 1200 can also include, couple with, or be integrated within a wearable device, such as a smart watch wearable device, a smart eyewear device, an augmented reality device, or a virtual reality device. In at least one embodiment, processing system 1200 is a television or set top box device having one or more processors 1202 and a graphical interface generated by one or more graphics processors 1208.

In at least one embodiment, one or more processors 1202 each include one or more processor cores 1207 to process instructions which, when executed, perform operations for system and user software. In at least one embodiment, each of one or more processor cores 1207 is configured to process a specific instruction sequence 1209. In at least one embodiment, instruction sequence 1209 may facilitate Complex Instruction Set Computing (CISC), Reduced Instruction Set Computing (RISC), or computing via a Very Long Instruction Word (VLIW). In at least one embodiment, processor cores 1207 may each process a different instruction sequence 1209, which may include instructions to facilitate emulation of other instruction sequences. In at least one embodiment, processor core 1207 may also include other processing devices, such a Digital Signal Processor (DSP).

In at least one embodiment, processor 1202 includes a cache memory 1204. In at least one embodiment, processor 1202 can have a single internal cache or multiple levels of internal cache. In at least one embodiment, cache memory is shared among various components of processor 1202. In at least one embodiment, processor 1202 also uses an external cache (e.g., a Level-3 (L3) cache or Last Level Cache (LLC)) (not shown), which may be shared among processor cores 1207 using known cache coherency techniques. In at least one embodiment, a register file 1206 is additionally included in processor 1202, which may include different types of registers for storing different types of data (e.g., integer registers, floating point registers, status registers, and an instruction pointer register). In at least one embodiment, register file 1206 may include general-purpose registers or other registers.

In at least one embodiment, one or more processor(s) 1202 are coupled with one or more interface bus(es) 1210 to transmit communication signals such as address, data, or control signals between processor 1202 and other components in system 1200. In at least one embodiment, interface bus 1210 can be a processor bus, such as a version of a Direct Media Interface (DMI) bus. In at least one embodiment, interface bus 1210 is not limited to a DMI bus, and may include one or more Peripheral Component Interconnect buses (e.g., PCI, PCI Express), memory busses, or other types of interface busses. In at least one embodiment processor(s) 1202 include an integrated memory controller 2016 and a platform controller hub 1230. In at least one embodiment, memory controller 2016 facilitates communication between a memory device and other components of system 1200, while platform controller hub (PCH) 1230 provides connections to I/O devices via a local I/O bus.

In at least one embodiment, a memory device 1220 can be a dynamic random access memory (DRAM) device, a static random access memory (SRAM) device, flash memory device, phase-change memory device, or some other memory device having suitable performance to serve as process memory. In at least one embodiment, memory device 1220 can operate as system memory for system 1200, to store data 1222 and instructions 1221 for use when one or more processors 1202 executes an application or process. In at least one embodiment, memory controller 2016 also couples with an optional external graphics processor 1212, which may communicate with one or more graphics processors 1208 in processors 1202 to perform graphics and media operations. In at least one embodiment, a display device 1211 can connect to processor(s) 1202. In at least one embodiment, display device 1211 can include one or more of an internal display device, as in a mobile electronic device or a laptop device, or an external display device attached via a display interface (e.g., DisplayPort, etc.). In at least one embodiment, display device 1211 can include a head mounted display (HMD) such as a stereoscopic display device for use in virtual reality (VR) applications or augmented reality (AR) applications.

In at least one embodiment, platform controller hub 1230 enables peripherals to connect to memory device 1220 and processor 1202 via a high-speed I/O bus. In at least one embodiment, I/O peripherals include, but are not limited to, an audio controller 1246, a network controller 1234, a firmware interface 1228, a wireless transceiver 1226, touch sensors 1225, a data storage device 1224 (e.g., hard disk drive, flash memory, etc.). In at least one embodiment, data storage device 1224 can connect via a storage interface (e.g., SATA) or via a peripheral bus, such as a Peripheral Component Interconnect bus (e.g., PCI, PCI Express). In at least one embodiment, touch sensors 1225 can include touch screen sensors, pressure sensors, or fingerprint sensors. In at least one embodiment, wireless transceiver 1226 can be a Wi-Fi transceiver, a Bluetooth transceiver, or a mobile network transceiver such as a 3G, 4G, or Long Term Evolution (LTE) transceiver. In at least one embodiment, firmware interface 1228 enables communication with system firmware, and can be, for example, a unified extensible firmware interface (UEFI). In at least one embodiment, network controller 1234 can enable a network connection to a wired network. In at least one embodiment, a high-performance network controller (not shown) couples with interface bus 1210. In at least one embodiment, audio controller 1246 is a multi-channel high definition audio controller. In at least one embodiment, system 1200 includes an optional legacy I/O controller 1240 for coupling legacy (e.g., Personal System 2 (PS/2)) devices to system 1200. In at least one embodiment, platform controller hub 1230 can also connect to one or more Universal Serial Bus (USB) controllers 1242 connect input devices, such as keyboard and mouse 1243 combinations, a camera 1244, or other USB input devices.

In at least one embodiment, an instance of memory controller 2016 and platform controller hub 1230 may be integrated into a discreet external graphics processor, such as external graphics processor 1212. In at least one embodiment, platform controller hub 1230 and/or memory controller 2016 may be external to one or more processor(s) 1202. For example, in at least one embodiment, system 1200 can include an external memory controller 2016 and platform controller hub 1230, which may be configured as a memory controller hub and peripheral controller hub within a system chipset that is in communication with processor(s) 1202.

Inference and/or training logic 115 are used to perform inferencing and/or training operations associated with one or more embodiments. In at least one embodiment portions or all of inference and/or training logic 115 may be incorporated into graphics processor 1200. For example, in at least one embodiment, training and/or inferencing techniques described herein may use one or more of ALUs embodied in a 3D pipeline. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

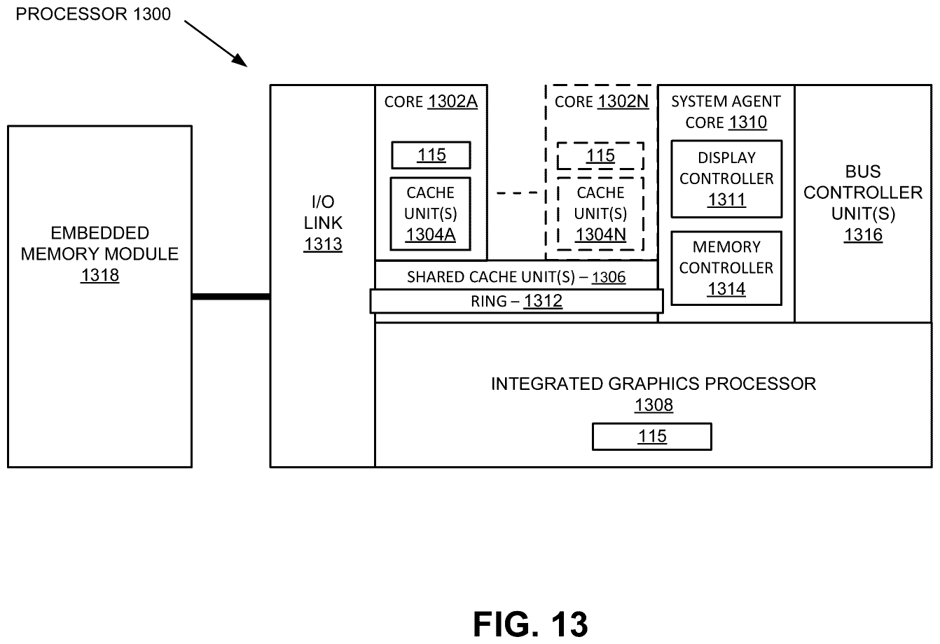

FIG. 13 is a block diagram of a processor 1300 having one or more processor cores 1302A-1302N, an integrated memory controller 1314, and an integrated graphics processor 1308, according to at least one embodiment. The processor of FIG. 13 may be used to execute post processing and other computational tasks of the graphics driver 106 executing commands generated by the application 104 and the swap chain adapter 126 of FIG. 1. In at least one embodiment, processor 1300 can include additional cores up to and including additional core 1302N represented by dashed lined boxes. In at least one embodiment, each of processor cores 1302A-1302N includes one or more internal cache units 1304A-1304N. In at least one embodiment, each processor core also has access to one or more shared cached units 1306.

In at least one embodiment, internal cache units 1304A-1304N and shared cache units 1306 represent a cache memory hierarchy within processor 1300. In at least one embodiment, cache memory units 1304A-1304N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1306 and 1304A-1304N.

In at least one embodiment, processor 1300 may also include a set of one or more bus controller units 1316 and a system agent core 1310. In at least one embodiment, bus controller units 1316 manage a set of peripheral buses, such as one or more PCI or PCI express busses. In at least one embodiment, system agent core 1310 provides management functionality for various processor components. In at least one embodiment, system agent core 1310 includes one or more integrated memory controllers 1314 to manage access to various external memory devices (not shown).

In at least one embodiment, one or more of processor cores 1302A-1302N include support for simultaneous multi-threading. In at least one embodiment, system agent core 1310 includes components for coordinating and operating cores 1302A-1302N during multi-threaded processing. In at least one embodiment, system agent core 1310 may additionally include a power control unit (PCU), which includes logic and components to regulate one or more power states of processor cores 1302A-1302N and graphics processor 1308.

In at least one embodiment, processor 1300 additionally includes graphics processor 1308 to execute graphics processing operations. In at least one embodiment, graphics processor 1308 couples with shared cache units 1306, and system agent core 1310, including one or more integrated memory controllers 1314. In at least one embodiment, system agent core 1310 also includes a display controller 1311 to drive graphics processor output to one or more coupled displays. In at least one embodiment, display controller 1311 may also be a separate module coupled with graphics processor 1308 via at least one interconnect, or may be integrated within graphics processor 1308.

In at least one embodiment, a ring-based interconnect unit 1312 is used to couple internal components of processor 1300. In at least one embodiment, an alternative interconnect unit may be used, such as a point-to-point interconnect, a switched interconnect, or other techniques. In at least one embodiment, graphics processor 1308 couples with ring interconnect 1312 via an I/O link 1313.

In at least one embodiment, I/O link 1313 represents at least one of multiple varieties of I/O interconnects, including an on package I/O interconnect which facilitates communication between various processor components and a high-performance embedded memory module 1318, such as an eDRAM module. In at least one embodiment, each of processor cores 1302A-1302N and graphics processor 1308 use embedded memory module 1318 as a shared Last Level Cache.

In at least one embodiment, processor cores 1302A-1302N are homogeneous cores executing a common instruction set architecture. In at least one embodiment, processor cores 1302A-1302N are heterogeneous in terms of instruction set architecture (ISA), where one or more of processor cores 1302A-1302N execute a common instruction set, while one or more other cores of processor cores 1302A-1302N executes a subset of a common instruction set or a different instruction set. In at least one embodiment, processor cores 1302A-1302N are heterogeneous in terms of microarchitecture, where one or more cores having a relatively higher power consumption couple with one or more power cores having a lower power consumption. In at least one embodiment, processor 1300 can be implemented on one or more chips or as an SoC integrated circuit.

Inference and/or training logic 115 are used to perform inferencing and/or training operations associated with one or more embodiments. In at least one embodiment portions or all of inference and/or training logic 115 may be incorporated into graphics processor 1310. For example, in at least one embodiment, training and/or inferencing techniques described herein may use one or more of ALUs embodied in a 3D pipeline, graphics core(s) 1302, shared function logic, or other logic in FIG. 13. In at least one embodiment, weight parameters may be stored in on-chip or off-chip memory and/or registers (shown or not shown) that configure ALUs of processor 1300 to perform one or more machine learning algorithms, neural network architectures, use cases, or training techniques described herein.

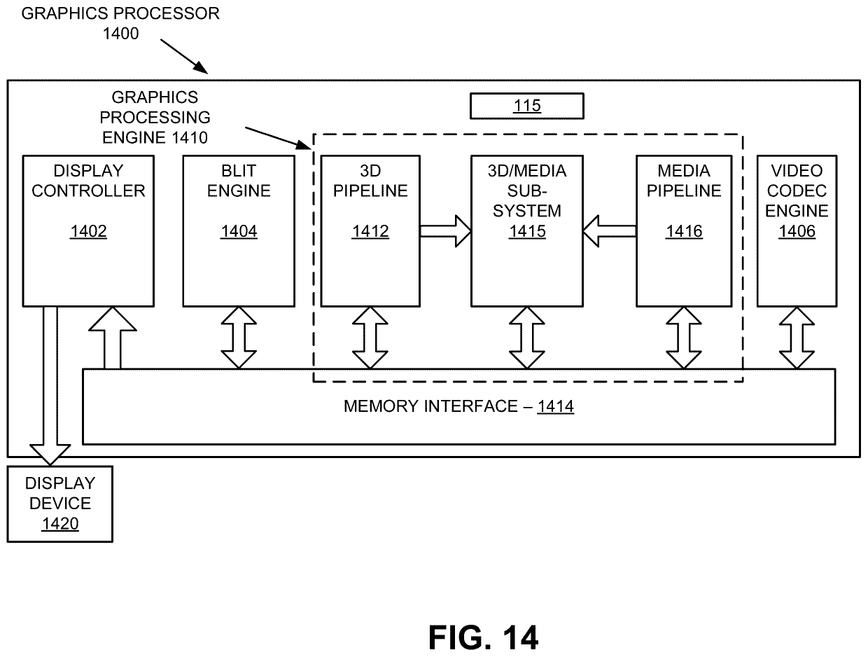

FIG. 14 is a block diagram of a graphics processor 1400, which may be a discrete graphics processing unit, or may be a graphics processor integrated with a plurality of processing cores. The graphics processor of FIG. 14 may be used to execute post processing and other computational tasks of the graphics driver 106 executing commands generated by the application 104 and the swap chain adapter 126 of FIG. 1. In at least one embodiment, graphics processor 1400 communicates via a memory mapped I/O interface to registers on graphics processor 1400 and with commands placed into memory. In at least one embodiment, graphics processor 1400 includes a memory interface 1414 to access memory. In at least one embodiment, memory interface 1414 is an interface to local memory, one or more internal caches, one or more shared external caches, and/or to system memory.

In at least one embodiment, graphics processor 1400 also includes a display controller 1402 to drive display output data to a display device 1420. In at least one embodiment, display controller 1402 includes hardware for one or more overlay planes for display device 1420 and composition of multiple layers of video or user interface elements. In at least one embodiment, display device 1420 can be an internal or external display device. In at least one embodiment, display device 1420 is a head mounted display device, such as a virtual reality (VR) display device or an augmented reality (AR) display device. In at least one embodiment, graphics processor 1400 includes a video codec engine 1406 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 421M/VC-1, and Joint Photographic Experts Group (JPEG) formats such as JPEG, and Motion JPEG (MJPEG) formats.

In at least one embodiment, graphics processor 1400 includes a block image transfer (BLIT) engine 1404 to perform two-dimensional (2D) rasterizer operations including, for example, bit-boundary block transfers. However, in at least one embodiment, 2D graphics operations are performed using one or more components of a graphics processing engine (GPE) 1410. In at least one embodiment, GPE 1410 is a compute engine for performing graphics operations, including three-dimensional (3D) graphics operations and media operations.

In at least one embodiment, GPE 1410 includes a 3D pipeline 1412 for performing 3D operations, such as rendering three-dimensional images and scenes using processing functions that act upon 3D primitive shapes (e.g., rectangle, triangle, etc.). In at least one embodiment, 3D pipeline 1412 includes programmable and fixed function elements that perform various tasks and/or spawn execution threads to a 3D/Media sub-system 1415. While 3D pipeline 1412 can be used to perform media operations, in at least one embodiment, GPE 1410 also includes a media pipeline 1416 that is used to perform media operations, such as video post-processing and image enhancement.

In at least one embodiment, media pipeline 1416 includes fixed function or programmable logic units to perform one or more specialized media operations, such as video decode acceleration, video de-interlacing, and video encode acceleration in place of, or on behalf of, video codec engine 1406. In at least one embodiment, media pipeline 1416 additionally includes a thread spawning unit to spawn threads for execution on 3D/Media sub-system 1415. In at least one embodiment, spawned threads perform computations for media operations on one or more graphics execution units included in 3D/Media sub-system 1415.

In at least one embodiment, 3D/Media subsystem 1415 includes logic for executing threads spawned by 3D pipeline 1412 and media pipeline 1416. In at least one embodiment, 3D pipeline 1412 and media pipeline 1416 send thread execution requests to 3D/Media subsystem 1415, which includes thread dispatch logic for arbitrating and dispatching various requests to available thread execution resources. In at least one embodiment, execution resources include an array of graphics execution units to process 3D and media threads. In at least one embodiment, 3D/Media subsystem 1415 includes one or more internal caches for thread instructions and data. In at least one embodiment, subsystem 1415 also includes shared memory, including registers and addressable memory, to share data between threads and to store output data.

Inference and/or training logic 115 are used to perform inferencing and/or training operations associated with one or more embodiments. In at least one embodiment portions or all of inference and/or training logic 115 may be incorporated into graphics processor 1400. For example, in at least one embodiment, training and/or inferencing techniques described herein may use one or more of ALUs embodied in 3D pipeline 1412. In at least one embodiment, weight parameters may be stored in on-chip or off-chip memory and/or registers (shown or not shown) that configure ALUs of graphics processor 1400 to perform one or more machine learning algorithms, neural network architectures, use cases, or training techniques described herein.

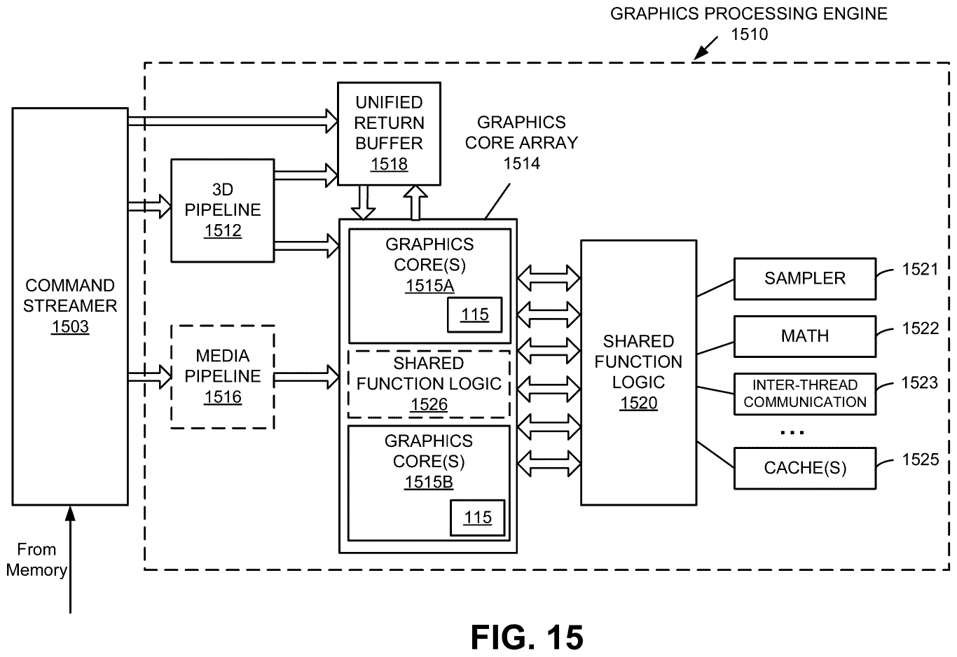

FIG. 15 is a block diagram of a graphics processing engine 1510 of a graphics processor in accordance with at least one embodiment. The graphics processoring engine of FIG. 15 may be used to execute post processing and other computational tasks of the graphics driver 106 executing commands generated by the application 104 and the swap chain adapter 126 of FIG. 1. In at least one embodiment, graphics processing engine (GPE) 1510 is a version of GPE 1410 shown in FIG. 14. In at least one embodiment, a media pipeline 1516 is optional and may not be explicitly included within GPE 1510. In at least one embodiment, a separate media and/or image processor is coupled to GPE 1510.

In at least one embodiment, GPE 1510 is coupled to or includes a command streamer 1503, which provides a command stream to a 3D pipeline 1512 and/or media pipeline 1516. In at least one embodiment, command streamer 1503 is coupled to memory, which can be system memory, or one or more of internal cache memory and shared cache memory. In at least one embodiment, command streamer 1503 receives commands from memory and sends commands to 3D pipeline 1512 and/or media pipeline 1516. In at least one embodiment, commands are instructions, primitives, or micro-operations fetched from a ring buffer, which stores commands for 3D pipeline 1512 and media pipeline 1516. In at least one embodiment, a ring buffer can additionally include batch command buffers storing batches of multiple commands. In at least one embodiment, commands for 3D pipeline 1512 can also include references to data stored in memory, such as, but not limited to, vertex and geometry data for 3D pipeline 1512 and/or image data and memory objects for media pipeline 1516. In at least one embodiment, 3D pipeline 1512 and media pipeline 1516 process commands and data by performing operations or by dispatching one or more execution threads to a graphics core array 1514. In at least one embodiment, graphics core array 1514 includes one or more blocks of graphics cores (e.g., graphics core(s) 1515A, graphics core(s) 1515B), each block including one or more graphics cores. In at least one embodiment, each graphics core includes a set of graphics execution resources that includes general-purpose and graphics specific execution logic to perform graphics and compute operations, as well as fixed function texture processing and/or machine learning and artificial intelligence acceleration logic, including inference and/or training logic 115.

In at least one embodiment, 3D pipeline 1512 includes fixed function and programmable logic to process one or more shader programs, such as vertex shaders, geometry shaders, pixel shaders, fragment shaders, compute shaders, or other shader programs, by processing instructions and dispatching execution threads to graphics core array 1514. In at least one embodiment, graphics core array 1514 provides a unified block of execution resources for use in processing shader programs. In at least one embodiment, a multi-purpose execution logic (e.g., execution units) within graphics core(s) 1515A-1515B of graphic core array 1514 includes support for various 3D API shader languages and can execute multiple simultaneous execution threads associated with multiple shaders.

In at least one embodiment, graphics core array 1514 also includes execution logic to perform media functions, such as video and/or image processing. In at least one embodiment, execution units additionally include general-purpose logic that is programmable to perform parallel general-purpose computational operations, in addition to graphics processing operations.

In at least one embodiment, output data generated by threads executing on graphics core array 1514 can output data to memory in a unified return buffer (URB) 1518. In at least one embodiment, URB 1518 can store data for multiple threads. In at least one embodiment, URB 1518 may be used to send data between different threads executing on graphics core array 1514. In at least one embodiment, URB 1518 may additionally be used for synchronization between threads on graphics core array 1514 and fixed function logic within shared function logic 1520.

In at least one embodiment, graphics core array 1514 is scalable, such that graphics core array 1514 includes a variable number of graphics cores, each having a variable number of execution units based on a target power and performance level of GPE 1510. In at least one embodiment, execution resources are dynamically scalable, such that execution resources may be enabled or disabled as needed.

In at least one embodiment, graphics core array 1514 is coupled to shared function logic 1520 that includes multiple resources that are shared between graphics cores in graphics core array 1514. In at least one embodiment, shared functions performed by shared function logic 1520 are embodied in hardware logic units that provide specialized supplemental functionality to graphics core array 1514. In at least one embodiment, shared function logic 1520 includes but is not limited to a sampler unit 1521, a math unit 1522, and inter-thread communication (ITC) logic 1523. In at least one embodiment, one or more cache(s) 1525 are included in, or coupled to, shared function logic 1520.

In at least one embodiment, a shared function is used if demand for a specialized function is insufficient for inclusion within graphics core array 1514. In at least one embodiment, a single instantiation of a specialized function is used in shared function logic 1520 and shared among other execution resources within graphics core array 1514. In at least one embodiment, specific shared functions within shared function logic 1520 that are used extensively by graphics core array 1514 may be included within shared function logic 2616 within graphics core array 1514. In at least one embodiment, shared function logic 2616 within graphics core array 1514 can include some or all logic within shared function logic 1520. In at least one embodiment, all logic elements within shared function logic 1520 may be duplicated within shared function logic 1526 of graphics core array 1514. In at least one embodiment, shared function logic 1520 is excluded in favor of shared function logic 1526 within graphics core array 1514.

Inference and/or training logic 115 are used to perform inferencing and/or training operations associated with one or more embodiments. In at least one embodiment portions or all of inference and/or training logic 115 may be incorporated into graphics processor 1510. For example, in at least one embodiment, training and/or inferencing techniques described herein may use one or more of ALUs embodied in 3D pipeline 1512, graphics core(s) 1515, shared function logic 1526, shared function logic 1520, or other logic in FIG. 15. In at least one embodiment, weight parameters may be stored in on-chip or off-chip memory and/or registers (shown or not shown) that configure ALUs of graphics processor 1510 to perform one or more machine learning algorithms, neural network architectures, use cases, or training techniques described herein.

portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other embodiment examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing computing device (“CPU”) executes some of instructions while a graphics processing computing device (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
intercepting, at a swap chain adapter of a graphics driver, a frame packet from an application, wherein the frame packet comprises a frame, frame data, and a first command for a swap chain of the graphics driver;
replacing, at the swap chain adapter of the graphics driver, the first command with a second command created based on the frame data, wherein the second command specifies at least one post processing operation to be performed on the frame;
providing, from the swap chain adapter of the graphics driver, an updated frame packet comprising at least the frame and the second command to the swap chain, wherein the second command causes a post processor to perform the at least one post processing operation on the frame to generate a post processed frame; and
causing a timed display of the post processed frame.

2. The method of claim 1, wherein the at least one post processing operation generates one or more additional frames based on the frame.

3. The method of claim 2, further comprising:
determining, using a timing coordinator, a frame rate for the post processed frame and the one or more additional frames.

4. The method of claim 2, wherein causing the timed display of the post processed frame comprises:
generating a third command to cause display of the post processed frame at a first time; and
generating a fourth command to cause display of at least one of the one or more additional frames at a second time that is after the first time.

5. The method of claim 1, wherein the first command from the application is to render or display the frame.

6. The method of claim 1, further comprising:
intercepting, at the swap chain adapter of the graphics driver, a third command from the application to display the post processed frame; and
providing, from the swap chain adapter of the graphics driver, a fourth command to the swap chain to display the post processed frame based on a frame rate from a timing coordinator.

7. The method of claim 1, wherein the frame data comprises at least one of resolution, frame buffer data, or synchronization data.

8. A computing system comprising:
a memory; and
one or more processors, coupled to the memory, to:
intercept, at a swap chain adapter of a graphics driver, a frame packet from an application, wherein the frame packet comprises a frame, frame data, and a first command for a swap chain of the graphics driver;
replace, at the swap chain adapter of the graphics driver, the first command with a second command created based on the frame data, wherein the second command specifies at least one post processing requirement of the frame;
provide, from the swap chain adapter of the graphics driver, an updated frame packet comprising at least the frame and the second command to the swap chain, wherein the second command a post processor to process the frame according to the at least one post processing requirement to generate a post processed frame; and
cause a timed display of the post processed frame.

9. The computing system of claim 8, wherein the post processor generates one or more additional frames based on the frame.

10. The computing system of claim 9, wherein the one or more processors are further to:
determine, using a timing coordinator, a frame rate for the post processed frame and the one or more additional frames.

11. The computing system of claim 9, wherein the one or more processors are further to:
generate a third command to cause display of the post processed frame at a first time; and
generate a fourth command to cause display of at least one of the one or more additional frames at a second time that is after the first time.

12. The computing system of claim 8, wherein the one or more processors are further to:
intercept, at the swap chain adapter of the graphics driver, a third command from the application to display the post processed frame; and
provide, from the swap chain adapter of the graphics driver, a fourth command to the swap chain to display the post processed frame based on a frame rate from a timing coordinator.

13. The computing system of claim 8, wherein the frame data comprises at least one of resolution, frame buffer data, or synchronization data.

14. One or more processors comprising:
processing circuitry to provide, to swap chain of a graphics driver, an updated frame packet generated by replacing an original command with a new command to cause post processing on a frame, the original command intended for the swap chain and is from an original frame packet intercepted from an application.

15. The one or more processors of claim 14, wherein the updated frame packet and the original frame packet further comprise frame data.

16. The one or more processors of claim 15, wherein the processing circuitry is further to generate the new command based on the original command and the frame data.

17. The one or more processors of claim 14, wherein the new command of the updated frame packet causes the swap chain to provide the frame to a post processor that performs the post processing to generate a post processed frame.

18. The one or more processors of claim 17, wherein the processing circuitry is further to cause a timed display of the post processed frame.

19. The one or more processors of claim 17, wherein the post processing comprises generating one or more additional frames and wherein the processing circuitry is further to cause display of the post processed frame at a first time and at least one of the one or more additional frames at a second time that is after the first time.

20. The one or more processors of claim 14, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.
